(19) United States
(12) Patent Application Publication
(10) Pub. No.: US 2021/0198532 A1
(43) Pub. Date: Jul. 1, 2021

(54) PRESSURE-SENSITIVE ADHESIVE SHEET FOR SURFACE PROTECTION

(71) Applicant: NITTO DENKO CORPORATION, Ibaraki-shi Osaka (JP)

(72) Inventors: Takuma OGAWA, Ibaraki-shi, Osaka (JP); Yoshio NAKAGAWA, Ibaraki-shi, Osaka (JP); Takeshi IGARASHI, Ibaraki-shi, Osaka (JP); Kaito YAMAMOTO, Ibaraki-shi, Osaka (JP)

(73) Assignee: NITTO DENKO CORPORATION, Ibaraki-shi Osaka (JP)

(21) Appl. No.: 17/057,996

(22) PCT Filed: May 21, 2019
(86) PCT No.: PCT/JP2019/020073

§ 371 Date: Nov. 23, 2020

(30) Foreign Application Priority Data
May 30, 2018 (JP) 2018-103994

(51) Int. Cl. C09J 7/38; C09J 133/06

(52) U.S. Cl. CPC C09J 7/385; C09J 2301/312; C09J 2203/306; C09J 133/064

(57) ABSTRACT

An objective is to provide a surface protective PSA sheet that has well-balanced bonding strength for various adherends differing in polarity and a capability to suppress peeling and lifting as well as an ability to inhibit touch-up paint peeling and an increase in bonding strength with time. The surface protective PSA sheet having a PSA layer and a resin substrate supporting the PSA layer, characterized by satisfying the following conditions (a1), (a1-1) and (c1) has well-balanced bonding strength for various adherends differing in polarity and is capable of suppressing peeling and lifting and inhibiting touch-up paint peeling and an increase in boding strength with time.
(a1) The PSA layer is formed from a PSA composition comprising a (meth)acrylic copolymer and a tackifier, the tackifier accounting for 1.0-30 parts by mass of the PSA composition with the (meth)acrylic copolymer being 100 parts by mass.
(a1-1) The (meth)acrylic copolymer comprises 0.1-2.8% by mass functional group-containing structural unit, the structural unit including at least one species of functional groups selected from the group consisting of a carboxyl group and a salt thereof as well as a sulfo group and a salt thereof.
(c1) The surface protective PSA sheet has tensile moduli of elasticity of 180-330 MPa in both MD and TD.

### TECHNICAL FIELD

The present invention relates to a pressure-sensitive adhesive (PSA) sheet for surface protection, in particular, to a surface protective PSA sheet used for preventing the surface of an article from getting damaged and accumulating dirt.

### BACKGROUND ART

To prevent damage and dirt accumulation in sort of manufacturing, transporting and storing automobiles, aircraft, watercraft and the like, procedures are carried out such as temporary adhesion of a resin PSA sheet to the surface of a finished product itself or a part and removal of the PSA sheet after an intended step or after a certain period. The PSA sheet used for such a purpose generally has a constitution that includes a PSA layer for adhesion to the adherend surface and a resin substrate to support the PSA layer, and material selection and dimensional design are carried out in consideration of the purpose.

To make a surface protective sheet having non-contaminating properties and excellent initial adhesion while reducing the build-up of distortion, for instance, Patent Document 1 suggests to use a non-crosslinked rubber-based polymer with a specific tackifier as PSA. On the other hand, Patent Document 2 suggests to form a PSA layer thinner than 10 μm and use a base polymer that includes isobutylene units for a PSA to obtain sufficient initial adhesion.

### CITATION LIST

### Patent Literature

### [Patent Document 1] Japanese Patent Application Publication No. 2014-019776

### [Patent Document 2] Japanese Patent Application Publication No. 2014-019777

### SUMMARY OF INVENTION

### Technical Problem

Interiors and exteriors of automobiles, aircraft, watercraft and the like include low-polar adherends such as plastic and high-polar adherends such as metal as well as both smooth and rough surfaces. PSA sheets used with them need to have balanced bonding strength for the respective adherends. For instance, it has been known that when a PSA sheet is applied over adherends varying greatly in polarity, it sometimes peels or lifts away from low-adhesive areas of the adherends, resulting in insufficient protection.

On the other hand, in automobile, aircraft, watercraft and the like, scratches formed on their painted surface and areas where underlying materials are exposed may be fixed by applying a coating so-called “touch-up paint”; the PSA sheet is sometimes applied to the touch-up painted areas as well. When the PSA sheet is highly adhesive, upon its removal, it could end up removing the touch-up paint itself, emerging as a new problem. In particular, as many touch-up paints use acrylic resin, extra caution is required especially when the PSA sheet uses acrylic PSA with high affinity to the acrylic resin. In addition, even when the bonding strength (initial bonding strength) is selected not to remove touch-up paint, some PSA would gain bonding strength with time; and when left as applied for a long time, problems may arise such as peeling of the touch-up paint and left-over PSA residue.

An objective of this invention is to provide a surface protective PSA sheet that has well-balanced bonding strength for various adherends differing in polarity and a capability to suppress peeling and lifting as well as an ability to inhibit touch-up paint peeling and an increase in bonding strength with time.

### Solution to Problem

By the present inventors, studies have been conducted to solve the problem. As a result, it has been found that a surface protective sheet satisfying certain conditions has well-balanced bonding strength for various adherends differing in polarity and a capability to suppress peeling and lifting as well as an ability to inhibit touch-up paint peeling and an increase in bonding strength with time, whereby this invention has been made.

In particular, the present invention is a

[symbol]

The surface protective PSA sheet as an embodiment of this invention (or sometimes abbreviated to “Embodiment 1”) has a PSA layer and a resin substrate supporting the PSA layer, characterized by satisfying the following conditions (a1), (a1-1) and (c1).

(a1) The PSA layer is formed from a PSA composition comprising a (meth)acrylic copolymer and a tackifier; and the tackifier content of the PSA composition is 1.0 part to 30 parts by mass with the (meth)acrylic copolymer being 100 parts by mass.

(a1-1) The (meth)acrylic copolymer comprises 0.1% to 2.8% by mass functional group-containing structural unit, the structural unit including at least one species of functional groups selected from the group consisting of a carboxyl group and a salt thereof as well as a sulfo group and a salt thereof.

(c1) The surface protective PSA sheet has a tensile modulus of elasticity of 180 MPa to 330 MPa in its machine direction (MD) as well as in its transverse direction (TD) perpendicular to the MD.

The species and/or amounts of tackifier and polar functional group of the (meth)acrylic copolymer are features related to the bonding strength with various low-polar and high-polar adherends as well as to the adhesion to touch-up paint and the increase in bonding strength with time. The modulus of elasticity of the surface protective PSA sheet is a feature related to the mechanical strength, conformability to adherend structures, peeling and lifting. For instance, when a poorly flexible surface protective PSA sheet is adhered over a curved adherend area, the repulsion (repulsive force) of the surface protective PSA sheet itself may cause peeling. In other words, the conditions (a1), (a1-1) and (c1) are selected from these viewpoints and Embodiment 1 is a surface protective PSA sheet that has well-balanced bonding strength for adherends differing in polarity and a capability to suppress peeling and lifting as well as an ability to inhibit touch-up paint peeling and an increase in bonding strength with time.

The surface protective PSA sheet as a preferable embodiment of this invention (or sometimes abbreviated to “Embodi [symbol] following condition (a1-2).

(a1-2) The (meth)acrylic copolymer has a weight average molecular weight of 100,000 to 1,500,000.

The weight average molecular weight of the (meth)acrylic copolymer is a feature related to the mechanical strength (especially the flexibility) of the PSA layer and affects the stress relief effect of the PSA layer. In other words, the condition (a1-2) is selected from this standpoint and Embodiment 2 is a surface protective PSA sheet having excellent stress relief effect and a capability to suppress peeling and lifting.

The surface protective PSA sheet as a preferable embodiment of this invention (or sometimes abbreviated to “Embodiment 3”) further satisfies the following condition (a1-3).

(a1-3) Of the (meth)acrylic copolymer, 20% to 80% by mass is attributed, as a structural unit, to at least one species of structure selected from the group consisting of a structure derived from a (meth)acrylate represented by the formula (x1) shown below and a structure derived from a (meth)acrylamide represented by the formula (y1) shown below.

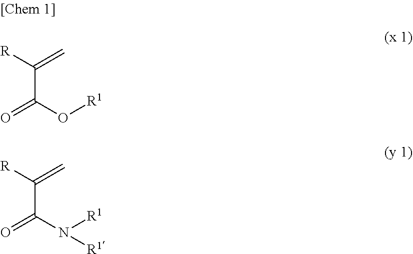

(In the formulas (x1) and (y1), R is a hydrogen atom or a methyl group; R¹ is a hydrocarbon group with 7 to 20 carbon atoms possibly including at least one species of functional groups selected from the group consisting of an oxa group, a carbonyl group and an oxycarbonyl group; and R^{1′} is a hydrogen atom or a hydrocarbon group with 1 to 6 carbon atoms possibly including at least one species of functional groups selected from the group consisting of an oxa group, a carbonyl group and an oxycarbonyl group.)

The amount of the sort of structure derived from a (meth)acrylate represented by the formula (x1) is a feature related to the miscibility with tackifier and affects the degree of freedom of the PSA layer's composition, etc. In other words, the condition (a1-3) is selected from this standpoint and Embodiment 3 is a surface protective PSA sheet with easy control over the PSA layer's composition, etc.

The surface protective PSA sheet as a preferable embodiment of this invention (or sometimes abbreviated to “Embodiment 4”) further satisfies the following condition (a1-4).

(a1-4) Of the (meth)acrylic copolymer, 20% to 80% by mass is attributed, as a structural unit, to at least one species of structure selected from the group consisting of a structure derived from a (meth)acrylate represented by the formula (x2) shown below and a structure derived from a (meth)acrylamide represented by the formula (y2) shown below.

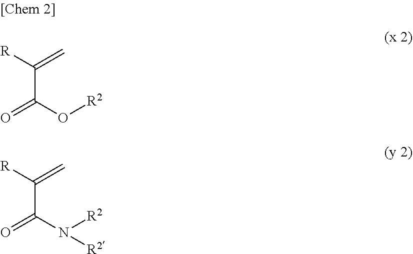

(In the formulas (x2) and (y2), R is a hydrogen atom or a methyl group; R² is a hydrocarbon group with 1 to 6 carbon atoms possibly including an oxa group; and R^{2′} is a hydrogen atom or a hydrocarbon group with 1 to 3 carbon atoms possibly including an oxa group.)

The amount of the sort of structure derived from a (meth)acrylate represented by the formula (x2) is a feature related to the molecular weight of the (meth)acrylic copolymer and indirectly affects the stress relief effect of the PSA layer. In other words, the condition (a1-4) is selected from this standpoint and Embodiment 4 is a surface protective PSA sheet with easy control over the molecular weight of the (meth)acrylic copolymer, etc.

The surface protective PSA sheet as a p [symbol] invention (or sometimes abbreviated to “Embodiment 5”) further satisfies the following condition (a1-5).

(a1-5) Of the (meth)acrylic copolymer, 0.05% to 1% by mass is attributed, as a structural unit, to at least one species of structure selected from the group consisting of a structure derived from a (meth)acrylate represented by the formula (x3) shown below and a structure derived from a (meth)acrylamide represented by the formula (y3) shown below.

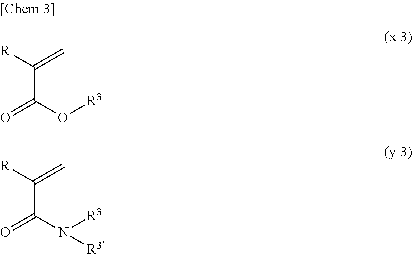

(In the formulas (x3) and (y3), R is a hydrogen atom or a methyl group; R³ is a hydroxyl group-containing hydrocarbon group with 1 to 12 carbon atoms possibly including an oxa group; and R^{3′} is a hydrogen atom or a hydroxyl group-containing hydrocarbon group with 1 to 3 carbon atoms possibly including an oxa group.)

The amount of the sort of structure derived from a (meth)acrylate represented by the formula (x3) is a feature related to the bonding strength and delocalization of moisture, affecting turbidity, etc., upon absorption of moisture and the like. In other words, the condition (a1-5) is selected from this standpoint and Embodiment 5 is a surface protective PSA sheet having excellent bonding strength as well as a capability to inhibit moisture localization and prevent clouding.

The surface protective PSA sheet as a preferable embodiment of this invention (or sometimes abbreviated to “Embodiment 6”) further satisfies the following condition (a1-6).

(a1-6) The PSA composition comprises, as the tackifier, an alicyclic hydrocarbon resin and a rosin resin, wherein the alicyclic hydrocarbon resin content of the PSA composition is 1.0 part to 20 parts by mass with the (meth)acrylic copolymer being 100 parts by mass, and the rosin resin con [symbol] to 28 parts by mass with the (meth)acrylic copolymer being 100 parts by mass.

The alicyclic hydrocarbon resin is a feature related to the surface state of the PSA layer and the rosin resin is a feature related to the bonding strength to low-polar adherends and the mechanical strength (especially the flexibility), affecting the PSA layer's stress relief, peeling and lifting. In other words, the condition (a1-6) is selected from this standpoint and Embodiment 6 is a surface protective PSA sheet having excellent bonding strength (especially to low-polar adherends) as well as a great stress relief effect and a capability to inhibit peeling and lifting.

The surface protective PSA sheet as a preferable embodiment of this invention (or sometimes abbreviated to “Embodiment 7”) further satisfies the following condition (a2).

(a2) The PSA layer has a thickness of 5.0 μm to 30 μm.

The PSA layer's thickness is a feature related to the mechanical strength (especially the flexibility) and affects the stress relief effect of the PSA layer. In other words, the condition (a2) is selected from this standpoint and Embodiment 7 is a surface protective PSA sheet having an excellent stress relief effect and a capability to inhibit peeling and lifting.

The surface protective PSA sheet as a preferable embodiment of this invention (or sometimes abbreviated to “Embodiment 8”) further satisfies the following condition (b1).

(b1) The resin substrate has a thickness of 30 μm to 70 μm.

The resin substrate's thickness is a feature related to the surface protective effect as well as peeling and lifting. In other words, the condition (b1) is selected from this standpoint and Embodiment 8 is a surface protective PSA sheet that can suppress peeling and lifting and bring about good surface protection.

The surface protective PSA sheet as a p [symbol] invention (or sometimes abbreviated to “Embodiment 9”) further satisfies the following condition (b2):

(b2) The resin substrate has a plurality of through holes pierced in the thickness direction of the resin substrate, appearing as lines and/or dots in shape on the resin substrate face, and arranged linearly and regularly in at least one direction, having a distance of 0.20 mm to 1.0 mm between adjacent through holes.

The through holes are a feature related to the ease of hand-cutting of the surface protective PSA sheet. In other words, the condition (b2) is selected from this standpoint and Embodiment 9 is a surface protective PSA sheet that can be easily hand cut to enable efficient application.

The surface protective PSA sheet as a preferable embodiment of this invention is to be removed after the protection purpose is fulfilled.

### Effect of Invention

The present invention provides a surface protective PSA sheet that has well-balanced bonding strength for adherends differing in polarity as well as an ability to inhibit touch-up paint peeling and an increase in bonding strength with time.

### BRIEF DESCRIPTION OF DRAWINGS

FIG. 1(A) to FIG. 1(D) show schematic diagrams (cross-sectional views) illustrating the layer structure of the surface protective PSA sheet as an embodiment of this invention.

FIG. 2 shows a schematic diagram (perspective view) illustrating through holes in the surface protective PSA sheet as an embodiment of this invention.

FIG. 3(A) and FIG. 3(B) respectively show schematic diagrams (plane views) illustrating through holes in the surface protective PSA sheet as an embodiment of this invention.

FIG. 4 shows a schematic diagram illustrating a constant load peel test for a surface protective PSA sheet.

FIG. 5(A) to FIG. 5(C) show schematic diagrams illustrating a repulsion test for a surface protective PSA sheet.

FIG. 6 shows a schematic diagram illustrating a strength-displacement curve of a tensile property test conducted in a 180° peel test.

### DESCRIPTION OF EMBODIMENTS

The present invention is described along with specific examples; however, it is not limited to the following content as long as it does not extend beyond the scope of this invention and it can be implemented with suitable modifications.

### <Surface Protective PSA Sheet>

The surface protective PSA sheet as an embodiment of this invention (hereinafter, sometimes abbreviated to the “surface protective PSA sheet) has a PSA layer (hereinafter, sometimes abbreviated to a “PSA layer”) and a PSA layer-supporting resin substrate (hereinafter, sometimes abbreviated to a “resin substrate), characterized by satisfying the conditions (a1), (a1-1) and (c1) below.

(a1) The PSA layer is formed from a PSA composition comprising a (meth)acrylic copolymer and a tackifier; and the tackifier content of the PSA composition is 1.0 part to 30 parts by mass with the (meth)acrylic copolymer being 100 parts by mass.

(a1-1) Of the (meth)acrylic copolymer, 0.1% to 2.8% by mass is attributed to a structural unit that includes at least one species of functional groups selected from the group consisting of a carboxyl group and a salt thereof as well as a sulfo group and a salt thereof.

(c1) The surface protective PSA sheet has a tensile modulus of elasticity of 180 MPa to 330 MPa in its machine direction (MD) as well as in its transverse direction (TD) perpendicular to the MD.

It has been revealed by the present inventors that the kinds and amounts of tackifier and polar functional groups of the (meth)acrylic copolymer are related to the bonding strength with various low-polar and high-polar adherends as well as to the adhesion to touch-up paint and the increase in bonding strength with time while the modulus of elasticity of the surface protective PSA sheet is related to the mechanical strength, conformability to adherend structures, peeling and lifting. In other words, it has been discovered that by satisfying conditi [symbol] surface protective PSA sheet can have well-balanced bonding strength for various adherends differing in polarity suppress peeling and lifting, and inhibit touch-up paint peeling and an increase in bonding strength with time.

The “(meth)acryl” as in “(meth)acrylic copolymer” or the like comprehensively means both methacryl and acryl.

### (a) PSA Layer

The PSA layer is formed from a PSA composition comprising a (meth)acrylic copolymer and a tackifier. The “(meth)acrylic copolymer” means either a copolymer that includes, as a structural unit, at least one species of structure selected from the group consisting of a structure (represented by the formula (X) shown below) formed by addition polymerization of a (meth)acrylate represented by the formula (x) shown below and a structure (represented by the formula (Y) shown below) formed by addition polymerization of a (meth)acrylamide represented by the formula (y); or a copolymer that includes, as a structural unit, a structure obtainable by modifying (esterifying or amidating) a carboxyl group of (meth)acrylic acid or a structure derived from (meth)acrylic acid with an amino group-containing compound or a hydroxyl group-containing compound such as polyglycerin and polyalkylene glycol. The amount of the “structural unit” in the (meth)acrylic copolymer refers to the mass of the corresponding monomer (starting material) used for synthesizing the (meth)acrylic copolymer (% by mass, with the total amount of monomers used being 100% by mass).

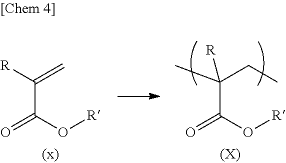

(In the formulas (x) and (X), R represents a hydrogen atom or a methyl group; and R′ represents a hydrocarbon group with 1 to 30 carbon atoms, the hydrocarbon group possibly including at least one species of functional groups selected from the group consisting of a hydroxyl group, carboxyl group, oxa group, glycidyl group, carbonyl group, oxycarbonyl group, amino group, amide g [symbol] group, fluoro group, chloro group, bromo group and iodo group.)

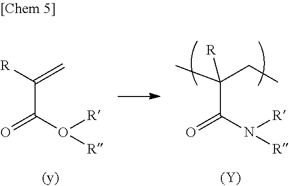

(In the formulas (y) and (Y), R represents a hydrogen atom or a methyl group; R′ represents a hydrocarbon group with 1 to 30 carbon atoms, the hydrocarbon group possibly including at least one species of functional groups selected from the group consisting of a hydroxyl group, carboxyl group, oxa group, glycidyl group, carbonyl group, oxycarbonyl group, amino group, amide group, cyano group, trialkoxysilyl group, fluoro group, chloro group, bromo group and iodo group); and R″ represents a hydrogen atom or a hydrocarbon group with 1 to 30 carbon atoms, the hydrocarbon group possibly including at least one species of functional groups selected from the group consisting of a hydroxyl group, carboxyl group, oxa group, glycidyl group, carbonyl group, oxycarbonyl group, amino group, amide group, cyano group, trialkoxysilyl group, fluoro group, chloro group, bromo group and iodo group.) “Possibly including at least one species of functional groups selected from the group consisting of a hydroxyl group . . . ” means that, as in —CH₂CH₂OH, a hydrogen atom of the hydrocarbon group can be substituted with a monovalent functional group such as a hydroxyl group as well as that, as in CH₂OCH₃, a carbon atom of the hydrocarbon group (methylene group) can be substituted with a divalent or higher multivalent functional group such as an oxy group.

The “hydrocarbon group” is not limited to a saturated linear hydrocarbon group. The term means that it may include a branched structure, a cyclic structure or a C—C unsaturated bond (C—C double bond, C—C triple bond). The term is meant to include an unsaturated hydrocarbon group and an aromatic hydrocarbon group.

Examples of (meth)acrylates and (meth)acrylamides represented by the formulas (x) and (y) include the compounds indicated by the formulas below. The compounds with formulas written below are con, [symbol] suitably obtained and incorporated as structural units into the (meth)acrylic copolymer.

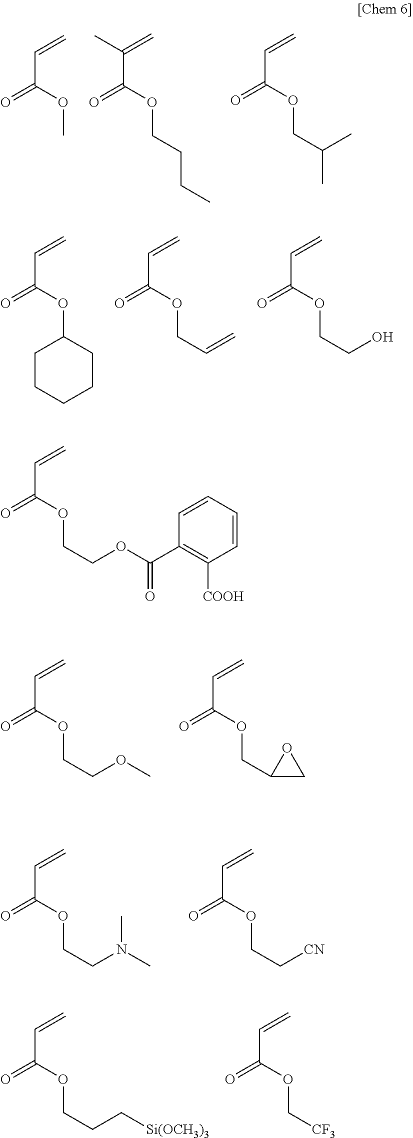

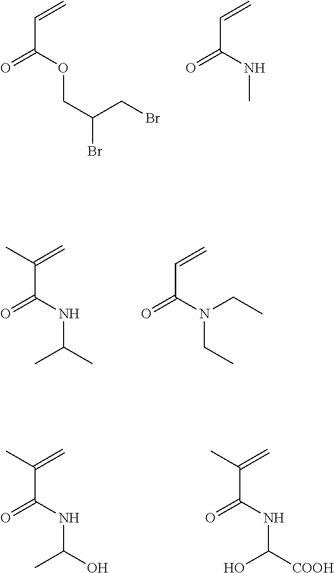

The “(meth)acrylic copolymer” is described in detail below.

The (meth)acrylic copolymer includes 0.1% to 2.8% by mass functional group-containing structural unit, the structural unit comprising at least one species of functional groups selected from the group consisting of a carboxyl group, a salt thereof, a sulfo group and a salt thereof. Hereinafter, the structural unit comprising at least one species of functional groups selected from the group consisting of a carboxyl group, a salt thereof, a sulfo group and a salt thereof is sometimes abbreviated to “carboxyl group/like-containing structural unit”. In the carboxyl group/like-containing structural unit, the number (per structural unit) of “at least one species of functional groups selected from the group consisting of a carboxyl group and a salt thereof as well as a sulfo group and a salt thereof” is typically 5 or lower, preferably 3 or lower, more preferably 2 or lower, or particularly preferably 1. When the carboxyl group/like-containing structural unit has two or more carboxyl groups, the carboxyl groups may be in an anhydrous form via dehydration condensation.

Examples of a non-carboxyl functional group included in the carboxyl group/like-containing structural unit include oxa group (—O), carbonyl group (—C(═O)—), oxycarbonyl group (—OC(═O)—), amino group (—N<), amide group (>NC(═O)—), fluoro group (—F), chloro group (—Cl), bromo group (—Br) and iodo group (—I).

The number of carbon atoms in the carboxyl group/like-containing structural unit is typically 3 or higher and typically 20 or lower, preferably 18 or lower, more preferably 16 or lower, yet more preferably 14 or [symbol] lower.

As the carboxyl group/like-containing structural unit, particularly preferable structures include structures derived from (meth)acrylic acid, (meth)acrylates, (meth)acrylamides and the like as represented by the formulas shown below. The compounds with formulas written below are commercially available and can be suitably obtained and incorporated as structural units into the (meth)acrylic copolymer.

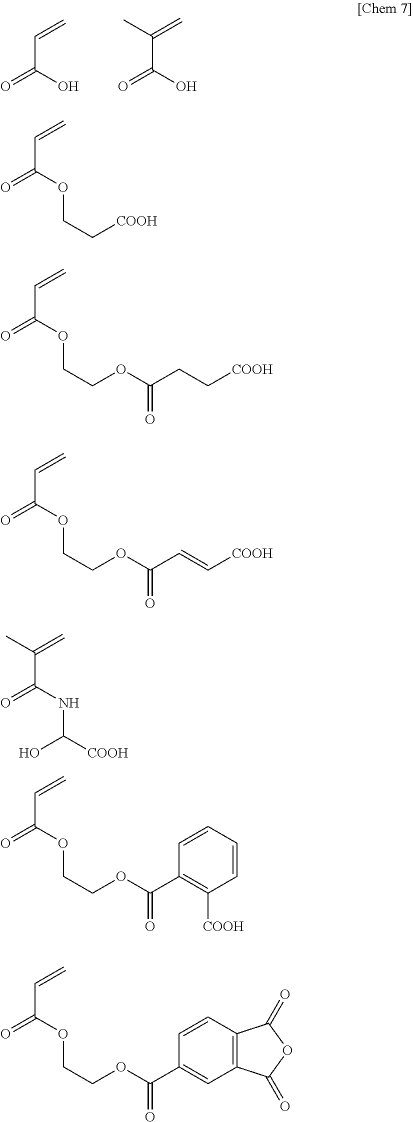

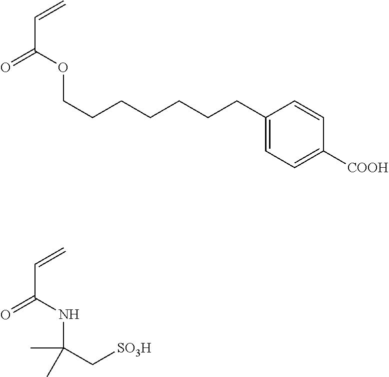

Examples of other carboxyl group/like-containing structural units include structures derived from OC unsaturated bond-containing compounds such as vinyl compounds, styrene-based compounds, allyl compounds and cyclic olefin compounds capable of forming copolymers with (meth)acrylates by addition polymerization (see the formulas below). The compounds with formulas written below are commercially available and can be suitably obtained and incorporated as structural units into the (meth)acrylic copolymer.

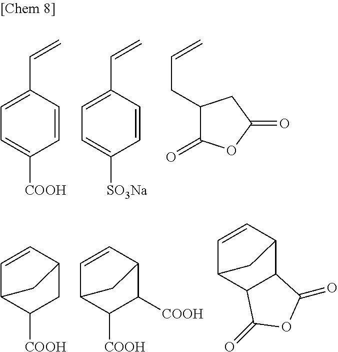

The amount of the carboxyl group/like-containing structural unit (the total amount when two or more species are included) in the (meth)acrylic copolymer is 0.1% to 2.8% by mass; preferably 0.2% by mass or [symbol] mass or greater, yet more preferably 0.6% by mass or greater, or particularly preferably 0.8% by mass or greater; and preferably 2.6% by mass or less, more preferably 2.3% by mass or less, yet more preferably 2.0% by mass or less, or particularly preferably 1.5% by mass or less. When it is in these ranges, with particularly well-balanced bonding strength for various adherends differing in polarity, touch-up paint peeling and an increase in bonding strength with time can be effectively inhibited.

The (meth)acrylic copolymer is not particularly limited as long as the copolymer includes 0.1% to 2.8% by mass carboxyl group/like-containing structural unit. The number of structural unit species including the carboxyl group/like-containing structural unit is typically 2 or higher, preferably 3 or higher, more preferably 4 or higher; and usually 8 or lower, or preferably 6 or lower. When it is in these ranges, the PSA layer's composition, the (meth)acrylic copolymer's molecular weight and the like can be easily controlled while reducing the manufacturing cost.

The structural units of the (meth)acrylic copolymer may include, besides the carboxyl group/like-containing structural unit, the structures derived from (meth)acrylates and (meth)acrylamides represented by the formulas (x1) and (y1) shown below.

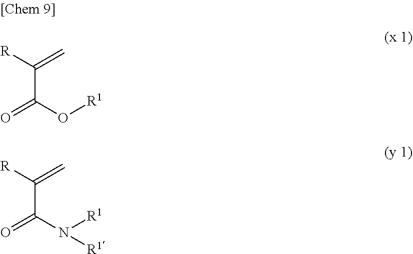

(In the formulas (x1) and (y1), R is a hydrogen atom or a methyl group; R¹ is a hydrocarbon group with 7 to 20 carbon atoms possibly including at least one species of functional groups selected from the group consisting of an oxa group, a carbonyl group and an oxycarbonyl group; and R^{1′} is a hydrogen atom or a hydrocarbon group with 1 to 6 carbon atoms possibly including at least one species of functional groups selected from the group consisting of an oxa group, a carbonyl group and an oxycarbonyl group.)

The structures derived from (meth)acrylates and (meth)acrylamides represented by the formulas (x1) and (y1) are features related to the miscibility with tackifier and affect the degree of freedom of the PSA layer's composition, etc.

The number of carbon atoms of R¹ in the formulas (x1) and (y1) is preferably 10 or lower, or more preferably 9 or lower.

The number of carbon atoms of R^{1′} in the formula (y1) is preferably 4 or lower, or more preferably 3 or lower.

Examples of the (meth)acrylates and (meth)acrylamides represented by the formulas (x1) and (y1) include the compounds represented by the formulas shown below. The compounds with formulas written below are commercially available and can be suitably obtained and incorporated as structural units into the (meth)acrylic copolymer. The compounds with formulas written below are commercially available and can be suitably obtained and incorporated as structural units into the (meth)acrylic copolymer.

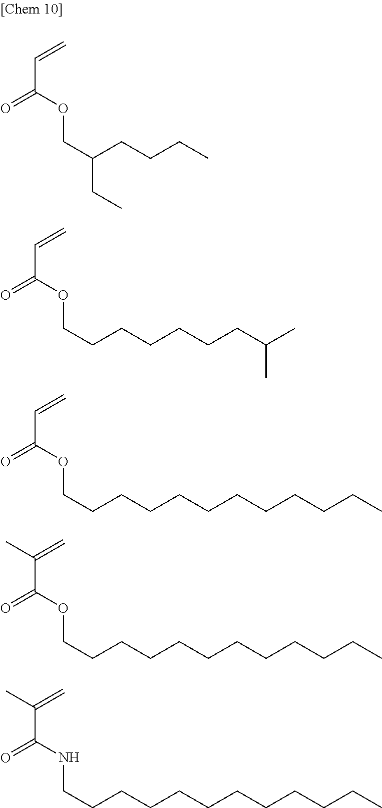

In the (meth)acrylic copolymer, the amount of at least one species of structure (as a structural unit) selected from the group consisting of a structure derived from a (meth)acrylate represented by the formula (x1) and a structure derived from a (meth)acrylamide represented by the formula (y1) (the total amount when two or more species are included) is typically 20% to 99% by mass; preferably 25% by mass or greater, more preferably 30% by mass or greater, yet more preferably 35% by mass or greater, or particularly preferably 40% by mass [symbol] mass or less, more preferably 80% by mass or less, yet more preferably 70% by mass or less, or particularly preferably 60% by mass or less. When it is in these ranges, the miscibility with tackifier can be effectively increased, making it easier to control the PSA layer's composition, etc.

The structural units of the (meth)acrylic copolymer besides the carboxyl group/like-containing structural unit may include structures derived from (meth)acrylates and (meth)acrylamides represented by the formulas (x2) and (y2) shown below.

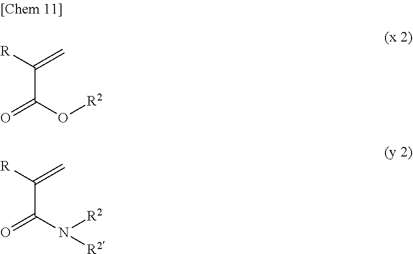

(In the formulas (x2) and (y2), R is a hydrogen atom or a methyl group; R² is a hydrocarbon group with 1 to 6 carbon atoms possibly including an oxa group; and R^{2′} is a hydrogen atom or a hydrocarbon group with 1 to 3 carbon atoms possibly including an oxa group.)

The structures derived from (meth)acrylates and (meth)acrylamides represented by the formulas (x2) and (y2) are features related to the molecular weight of the (meth)acrylic copolymer and indirectly affects the stress relief effect of the PSA layer.

The number of carbon atoms of R² in the formulas (x2) and (y2) is preferably 5 or lower, or more preferably 4 or lower.

Examples of the (meth)acrylates and (meth)acrylamides represented by the formulas (x2) and (y2) include the compounds represented by the formulas shown below. The compounds with formulas written below are commercially available and can be suitably obtained and incorporated as structural units into the (meth)acrylic copolymer. The compounds with formulas written below are commercially available and can be suitably obtained and incorporated a [symbol] (meth)acrylic copolymer.

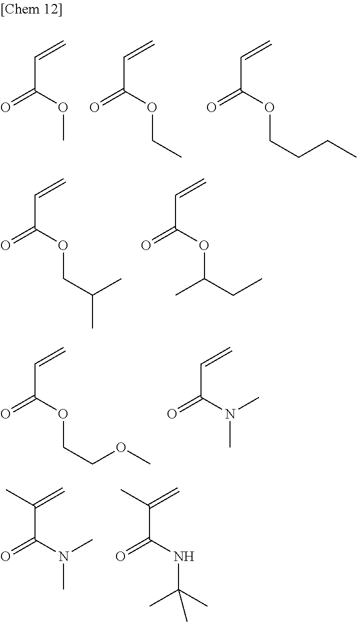

In the (meth)acrylic copolymer, the amount of at least one species of structure (as a structural unit) selected from the group consisting of a structure derived from a (meth)acrylate represented by the formula (x2) and a structure derived from a (meth)acrylamide represented by the formula (y2) (the total amount when two or more species are included) is typically 20% to 80% by mass; preferably 25% by mass or greater, more preferably 30% by mass or greater, yet more preferably 35% by mass or greater, or particularly preferably 40% by mass or greater; and preferably 75% by mass or less, more preferably 70% by mass or less, yet more preferably 65% by mass or less, or particularly preferably 60% by mass or less. When it is in these ranges, it will be easier to control the (meth)acrylic copolymer's molecular weight, etc.

The structural units of the (meth)acrylic copolymer besides the carboxyl group/like-containing structural unit may include structures derived from (meth)acrylates and (meth)acrylamides represented by the formulas (x3) and (y3) shown below.

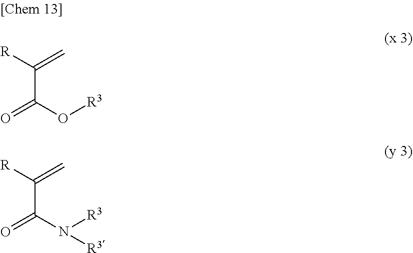

(In the formulas (x3) and (y3), R is a hydrogen atom or a methyl group; R³ is a hydroxyl group-containing hydrocarbon group with 1 to 12 carbon atoms possibly including an oxa group; and R^{3′} is a hydrogen atom or a hydroxyl group-containing hydrocarbon group with 1 to 3 carbon atoms possibly including an oxa group.) The “hydroxyl group” in the formulas (x3) and (y3) does not include the hydroxyl groups of carboxyl group, sulfo group and the like.

The structures derived from (meth)acrylates and (meth)acrylamides represented by the formulas (x3) and (y3), respectively are features related to the bonding strength and delocalization of moisture, affecting turbidity and the like upon absorption of moisture, etc.

The number of carbon atoms of R² in the formulas (x3) and (y3) is preferably 10 or lower, more preferably 8 or lower, yet more preferably 6 or lower, or particularly preferably 4 or lower.

Examples of the (meth)acrylates and (meth)acrylamides represented by the formulas (x3) and (y3) include the compounds represented by the formulas shown below. The compounds with formulas written below are commercially available and can be suitably obtained and incorporated as structural units into the (meth)acrylic copolymer. The compounds with formulas written below are commercially available and can be suitably obtained and incorporated as structural units into the (meth)acrylic copolymer.

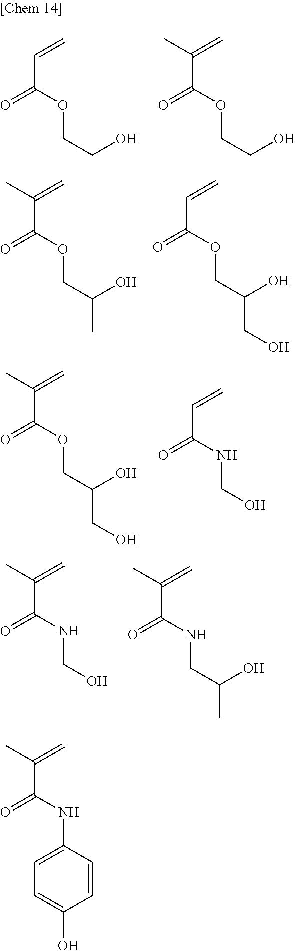

In the (meth)acrylic copolymer, the amount of at least one species of structure (as a structural unit) selected from the group consisting of a structure derived from a (meth)acrylate represented by the formula (x3) and a structure derived from a (meth)acrylamide represented by the formula (y3) (the total amount when two or more species are included) is typically 0.05% to 1% by mass; preferably 0.06% by mass or greater, more preferably 0.08% by mass or greater, yet more preferably 0.10% by mass or greater, or particularly preferably 0.12% by mass or greater; and preferably 0.8% by mass or less, more preferably 0.5% by mass or less, yet more preferably 0.3% by mass or less, or particularly preferably 0.2% by mass or less. When it is in these ranges, excellent bonding strength can be obtained while moisture localization can be inhibited to effectively prevent clouding.

The (meth)acrylic copolymer may include other structures as structural units as long as the copolymer includes, as a structural unit, at least one species of structure selected from the group consisting of structures formed from (meth)acrylates represented by the formula (x) and structures formed from (meth)acrylamides represented by the formula (y), etc. Examples of the other structures include C—C unsaturated bond-containing compounds such as vinyl compounds, styrene-based compounds, allyl compounds and cyclic olefin compounds capable of forming copolymers with (meth)acrylates and the like by addition polymerization.

In the (meth)acrylic copolymer, the tota [symbol] structure (as a structural unit) selected from the group consisting of a structure derived from a (meth)acrylate represented by the formula (x) and a structure derived from a (meth)acrylamide represented by the formula (y) (the total amount when two or more species are included) is typically 50% by mass or greater; preferably 60% by mass or greater, more preferably 70% by mass or greater, yet more preferably 80% by mass or greater, particularly preferably 90% by mass or greater, or most preferably 100% by mass. When it is in these ranges, with particularly well-balanced bonding strength for various adherends differing in polarity, touch-up paint peeling and an increase in bonding strength with time can be effectively inhibited.

As for the polymerization method and conditions for producing the (meth)acrylic copolymer, known polymerization methods and conditions can be suitably employed, such as solution polymerization, bulk polymerization, suspension polymerization and emulsion polymerization.

Examples of polymerization initiator include azo polymerization initiators as those represented by the formulas shown below. The compounds with formulas written below are commercially available and can be suitably obtained and used in producing the (meth)acrylic copolymer.

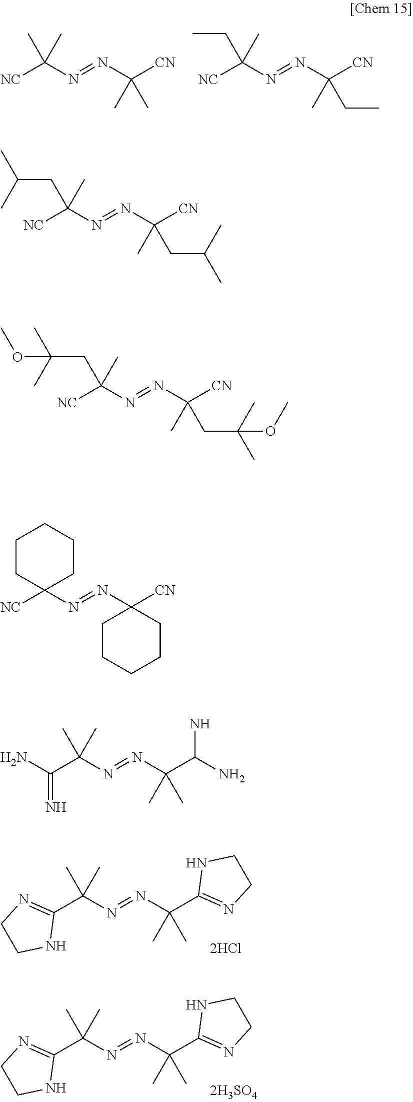

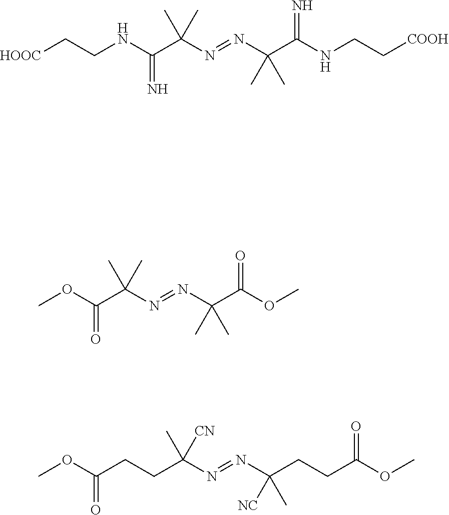

The (meth)acrylic copolymer has a weight average molecular weight (Mw) of typically 100,000 to 1,500,000, preferably 200,000 or higher, more preferably 400,000 or higher, yet more preferably 600,000 or higher, particularly preferably 650,000 or higher, or most preferably 700,000 or greater and preferably 1,400,000 or lower, or more preferably 1,300,000 or lower. When it is [symbol] particularly well, enabling effective inhibition of peeling and lifting.

The PSA layer is formed from a PSA composition comprising the (meth)acrylic copolymer and a tackifier. The “tackifier” refers to a known additive used to provide tack (stickiness) and so on. It is generally a thermoplastic resin in a liquid or solid state at room temperature.

Examples of the tackifier include natural resin-based species such as rosin-based resins (rosin (gum rosin, tall rosin, wood rosin), modified rosins (hydrogenated rosins, disproportionated rosins, polymerized rosins), rosin esters) and terpene-based resins (terpene resins (α-pinene-based species, β-pinene-based species, dipentene, etc.), aromatic modified terpene resins, hydrogenated terpene resins, terpene phenol resin); and synthetic resins such as aliphatic hydrocarbon resins, aromatic hydrocarbon resins, aliphatic aromatic hydrocarbon copolymer resins, alicyclic hydrocarbon resins, styrene resins, phenol resins (alkyl phenol resins, rosin-modified phenol resins, etc.) and xylene resins.

The tackifier has a softening point of usually 60° C. to 180° C., preferably 90° C. or higher, more preferably 110° C. or higher, or yet more preferably 120° C. or higher. When it is in these ranges, so-called “fogging” where the windshield of an automobile is fogged can be reduced. The tackifier's softening point refers to a value determined by the softening point test method (ring and ball method) specified in JIS K5902:2006 or JIS K2207:2006.

The amount of tackifier (the total amount when two or more species are included) in the PSA composition is 1.0 part to 30 parts by mass with the (meth)acrylic copolymer being 100 parts by mass; and it is preferably 2.0 parts by mass or greater, more preferably 4.0 parts by mass or greater, yet more preferably 8.0 parts by mass or greater, or particularly preferably 12 parts by mass or greater; and preferably 26 parts by mass or less, more preferably 22 parts by mass or less, yet more preferably 18 parts by mass or less, or particularly preferably 16 parts by mass or less. When it is in these ranges, with particularly well-balanced bonding strength for various adherends differing in polarity, touch-up paint peeling and an increase in bonding strength with time can be effectively inhibited.

As for the tackifier, it is preferable to use two or more species, typically up to five species or preferably up to four species. Described below in detail is an embodiment where two or more species of tackifier are used.

When two or more species of tackifier are used, it is preferable to include an alicyclic hydrocarbon resin and a rosin resin. The alicyclic hydrocarbon resin works to improve the surface state of the PSA layer and increase the bonding strength with low-polar adherends. The rosin resin works to enhance the stress relief effect of the PSA layer.

Preferable alicyclic hydrocarbon resins are produced by hydrogenation of aromatic hydrocarbon resins, such as ARKON (P series, M series, products with various softening points are sold) available from Arakawa Chemical Industries, Ltd., T-REZ (H series) available from JXTG Nippon Oil & Energy Corporation, and I-MARV available from Idemitsu Kosan Co., Ltd.

As for rosin resins, rosin esters (especially polymerized rosin esters) are preferable, such as PENSEL (D series, C, KK, products with various softening points are sold) available from Arakawa Chemical Industries, Ltd.

The amount of alicyclic hydrocarbon resin (the total amount when two or more species are included) in the PSA composition is 1.0 part to 20 parts by mass with the (meth)acrylic copolymer being 100 parts by mass; and it is preferably 1.5 parts by mass or greater, more preferably 2.0 parts by mass or greater, yet more preferably 2.5 parts by mass or greater, or particularly preferably 3.0 parts by mass or greater; and preferably 18 parts by mass or less, more preferably 14 parts by mass or less, yet more preferably 12 parts by mass or less, particularly preferably 10 parts by mass or less, or most preferably 7.0 parts by mass or less. When it is in these ranges, the surface state of the PSA layer can be maintained well with effective inhibition of peeling and lifting. In addition, excessive bonding to a high-polar adherend such as metal can be avoided, and capable of preventing glass haze.

The amount of rosin resin (the total amount when two or more species are included) in the PSA composition is 1.0 part to 30 parts by mass with the (meth)acrylic copolymer being 100 parts by mass; and it is pre [symbol] more preferably 4.0 parts by mass or greater, yet more preferably 6.0 parts by mass or greater, or particularly preferably 8.0 parts by mass or greater; and preferably 25 parts by mass or less, more preferably 20 parts by mass or less, yet more preferably 16 parts by mass or less, particularly preferably 12 parts by mass or less, or most preferably 10 parts by mass or less. When it is in these ranges, with particularly great bonding strength (especially for low-polar adherends) as well as an excellent stress relief effect, peeling and lifting can be effectively suppressed.

The PSA layer is formed with a PSA composition comprising a (meth)acrylic copolymer and a tackifier. Examples of the method for forming the PSA layer include a direct method where the PSA composition is applied to a resin substrate and a transfer method where a layer is formed from the PSA composition and transferred to a resin substrate.

The means of applying the PSA composition include a gravure roll coater, dip roll coater and die coater.

When the applied PSA composition is heated to dry, the temperature is usually 40° C. to 150° C., preferably 60° C. or above and preferably 130° C. or below.

The PSA composition may comprise other compounds besides the (meth)acrylic copolymer and the tackifier, and preferably includes a crosslinking agent. The inclusion of crosslinking agent facilitates production of surface protective PSA sheets having well-balanced bonding strength.

Examples of the crosslinking agent include an epoxy-based crosslinking agent that includes two or more epoxy groups capable of reacting with a carboxyl group, hydroxyl group, mercapto group, isocyanate group, (PC unsaturated bond, etc.; an isocyanate-based crosslinking agent that includes two or more isocyanate groups capable of reacting with a carboxyl group, hydroxyl group, mercapto group, amino group, etc.; and an oxazoline-based crosslinking agent that includes two or more oxazoline moieties capable of reacting with a carboxyl group, hydroxyl group, etc. Epoxy-based and isocyanate-based crosslinking agents represented by the formulas shown below are preferable, and epoxy-based crosslinking agents are particularly preferable. An epoxy-based crosslinking agent will make it easier to produce a surface protective PSA sheet with well-balanced [symbol] with formulas written below are commercially available and can be suitably obtained and used in forming the PSA layer. Examples include TETRAD-C available from Mitsubishi Gas Chemical Company Inc.

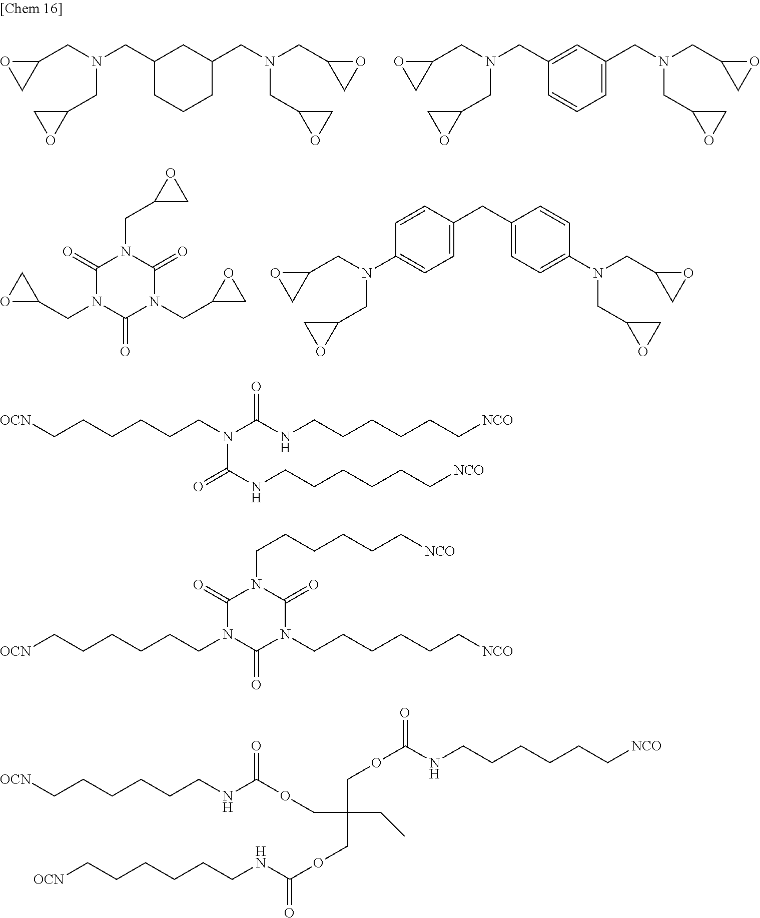

The amount of crosslinking agent (the total amount when two or more species are included) in the PSA composition is 0.01 part to 0.5 part by mass with the (meth)acrylic copolymer being 100 parts by mass; and it is preferably 0.02 part by mass or greater, more preferably 0.03 part by mass or greater, yet more preferably 0.05 part by mass or greater, or particularly preferably 0.07 part by mass or greater; and preferably 0.3 part by mass or less, more preferably 0.25 part by mass or less, yet more preferably 0.2 part by mass or less, or particularly preferably 0.15 part by mass or less. When it is in these ranges, it is easier to produce a surface protective PSA sheet having well-balanced bonding strength for various adherends varying in polarity.

The PSA layer and the PSA composition may include compounds other than the (meth)acrylic copolymer, tackifier and crossl [symbol] additives include leveling agent, crosslinking aid, plasticizer, softener, filler, colorant (pigment, dye, etc.), antistatic agent, anti-aging agent, UV absorber, antioxidant, photo-stabilizer, etc.

The PSA layer has a thickness of typically 5.0 μm to 30 μm, preferably 8.0 μm or greater, more preferably 10 μm or greater, yet more preferably 12 μm or greater, or particularly preferably 14 μm or greater; and preferably 25 μm or less, more preferably 22 μm or less, yet more preferably 20 μm or less, or particularly preferably 18 μm or less. When it is in these ranges, a great stress relief effect is obtained while peeling and lifting can be effectively suppressed. The thickness of the PSA layer refers to a value determined by a cross-sectional analysis using an optical microscope, electron microscope, etc.

### (b) Resin Substrate

The polymer species of the resin substrate can be polyolefin resin such as polyethylene (PE) and polypropylene (PP); polyester resin such as polyethylene terephthalate; fluororesin such as polytetrafluoroethylene; polystyrene resin; polyimide resin; polycarbonate resin; polyurethane resin; and polyvinyl chloride resin. Polyolefin resin is particularly preferable.

The polymer species of the resin substrate is not limited to a homopolymer formed from one monomer species. It can be a random copolymer or block copolymer formed from two or more monomer species.

The resin substrate is not limited to a species formed from one polymer species. It can be an alloy blend (miscible alloy, immiscible alloy) containing two or more polymer species. It is particularly preferable to include polyethylene (PE) and polypropylene (PP). A specific example is TRETEC CF47W available from Toray Advanced Film Co., Ltd.

The resin substrate including polyethylene (PE) and polypropylene (PP) is described in detail below.

The polyethylene (PE) has a density of typically 0.90 g/cm³ to 0.97 g/cm³, preferably 0.96 g/cm³ or less, more preferably 0.95 g/cm³ or less, or yet more preferably 0.94 g/cm³ or less. When it is in these ranges, c [symbol] is readily obtained. The density of polyethylene refers to a value determined based on ISO 1183-1:2012.

The polyethylene (PE) has a Shore hardness of typically D41 to D70, preferably D65 or less, more preferably D60 or less, or yet more preferably D55 or less. When it is in these ranges, conformability to adherend structures is readily obtained.

The amount of polyethylene (PE) (the total amount when two or more species are included) in the resin substrate is typically 1% to 40% by mass, preferably 3% by mass or greater, more preferably 5% by mass or greater, yet more preferably 8% by mass or greater, or particularly preferably 10% by mass or greater; and preferably 35% by mass or less, more preferably 30% by mass or less, yet more preferably 25% by mass or less, or particularly preferably 20% by mass or less. When it is in these ranges, conformability to adherend structures is readily obtained.

The polypropylene (PP) has a density of typically 0.90 g/cm³ to 0.91 g/cm³, preferably 0.901 g/cm³ or greater, more preferably 0.902 g/cm³ or greater, yet more preferably 0.903 g/cm³ or greater, or particularly preferably 0.904 g/cm³ or greater; and preferably 0.909 g/cm³ or less, more preferably 0.908 g/cm³ or less, yet more preferably 0.907 g/cm³ or less, or particularly preferably 0.906 g/cm³ or less. When it is in these ranges, mechanical strength is readily obtained. The density of polypropylene refers to a value determined based on ISO 1183-1:2012.

The polypropylene (PP) has a Rockwell hardness of typically R80 to R110, preferably R85 or greater, more preferably R86 or greater, yet more preferably R87 or greater, or particularly preferably R90 or greater; and preferably R105 or less, more preferably R100 or less, yet more preferably R98 or less, or particularly preferably R90 or less. When it is in these ranges, mechanical strength is readily obtained.

The amount of polypropylene (PP) (the total amount when two or more species are included) in the resin substrate is typically 60% to 99% by mass, preferably 65% by mass or greater, more preferably 70% by mass or greater, yet more preferably 75% by mass or greater, or particula [symbol] and preferably 97% by mass or less, more preferably 95% by mass or less, yet more preferably 92% by mass or less, or particularly preferably 90% by mass or less. When it is in these ranges, mechanical strength is readily obtained.

The resin substrate may include additives in accordance with the purpose, such as known pigment, filler, antioxidant, photo stabilizer (including radical scavenger and UV absorber), slip agent and anti-blocking agent.

The resin substrate may be subjected to surface treatment in accordance with the purpose, such as known acid treatment, corona discharge treatment, UV irradiation, plasma treatment and release treatment.

The resin substrate has a thickness of typically 30 μm to 70 μm, preferably 35 μm or greater, or more preferably 40 μm or greater; and preferably 65 μm or less, or more preferably 60 μm or less. When it is in these ranges, mechanical strength and conformability to adherend structures are readily obtained while peeling and lifting can be effectively suppressed. The thickness of the resin substrate refers to a value determined by a cross-sectional analysis using an optical microscope, electron microscope, etc.

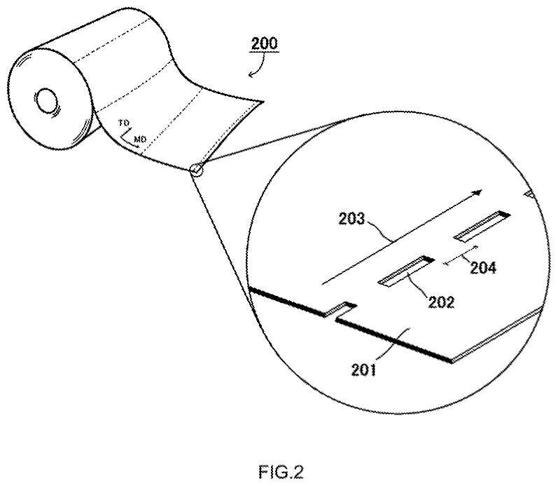

The resin substrate preferably has a plurality of through holes pierced in the thickness direction of the resin substrate, lined and/or dotted in shape on the resin substrate face, and arranged linearly and regularly in at least one direction, preferably having a distance of 0.20 mm to 1.0 mm between adjacent through holes. FIG. 2 shows a schematic diagram (perspective view) illustrating part of a surface protective PSA sheet 200 with through holes. Through holes 202 appear macroscopically as lines (microscopically as rectangles) in shape on resin substrate face 201 are linearly and regularly arranged in parallel with direction 203. The distance 204 between adjacent through holes 202 is in the range between 0.20 mm and 1.0 mm and all adjacent through holes are apart by the same distance. Having through holes as described above, the surface protective PSA sheet can be easily hand-cut and can be efficiently applied. It is preferable that the through holes pierce through the thickness (in the thickness directio [symbol] piercing through not only the resin substrate, but also the PSA layer at the same locations as the resin substrate.

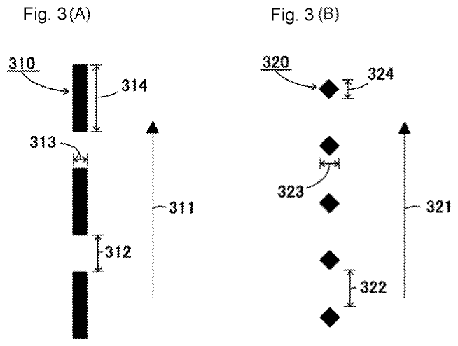

The through hole shape can be a dot or line as those shown in FIGS. 3(A) and 3(B).

FIGS. 3(A) and 3 (B) show schematic diagrams representing through holes (the resin substrate face in plane views). FIG. 3(A) shows an example where through holes 310 appearing macroscopically as lines (microscopically as rectangles) in shape on the resin substrate face are arranged linearly and regularly in parallel with the direction 311. FIG. 3(B) shows an example where through holes 320 appearing macroscopically as dots (microscopically as squares) on the resin substrate face are arranged linearly and regularly in parallel with the direction 321.

The distance (204 in FIG. 2, 312 in FIG. 3(A), 322 in FIG. 3(B)) between adjacent through holes is typically 0.20 mm to 1.0 mm; preferably 0.30 mm or greater, more preferably 0.40 mm or greater, yet more preferably 0.50 mm or greater; and preferably 0.90 mm or less, more preferably 0.80 mm or less, or yet more preferably 0.70 mm or less. When it is in these ranges, cutting can be further facilitated.

A through hole in the resin substrate face has a short side (313 in FIG. 3(A), diameters 323 in the arranged direction 321 and 324 in the direction perpendicular to the arranged direction 321 with respect to a dot-shaped through hole as shown in FIG. 3(B)) of typically 20 μm to 400 μm; preferably 30 μm or greater, more preferably 40 μm or greater, yet more preferably 60 μm or greater; and preferably 360 μm or less, more preferably 340 μm or less, or yet more preferably 320 μm or less. When it is in these ranges, cutting can be further facilitated.

A linear through hole in the resin substrate face has a long side (314 in FIG. 3(A)) of typically 0.50 mm to 1.5 mm; preferably 0.60 mm or greater, more preferably 0.80 mm or greater, or yet more preferably 0.90 mm or greater; and preferably 1.4 mm or less, more preferably 1.3 mm or less, or yet more preferably 1.2 mm or less. When it is in these ranges, cutting can be further facilitated.

The method for forming the through holes is not particularly limited and known methods can be suitably employed. Examples of such methods include typically piercing the resin substrate or the surface protective PSA sheet with a cutter having a shape corresponding to the through holes, laser piercing the resin substrate or the surface protective PSA sheet. Examples of the cutter method for forming through holes include rotary cutting and guillotine cutting.

### (c) Surface Protective PSA Sheet

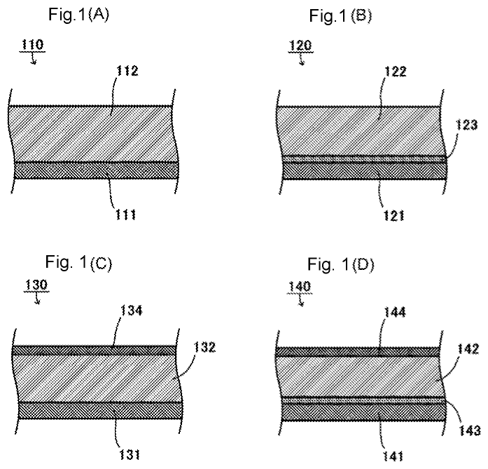

The surface protective PSA sheet may have other layers as long as it has a PSA layer and a resin substrate supporting the PSA layer. For instance, as the surface protective PSA sheet 110 in FIG. 1(A), it may solely have a PSA layer 111 and a resin substrate 112. As the surface protective PSA sheet 120 shown in FIG. 1(B), it may have a middle layer 123 in addition to a PSA layer 121 and a resin substrate 122. As the surface protective PSA sheet 130 shown in FIG. 1(C), it may have a surface layer 134 in addition to a PSA layer 131 and a resin substrate 132. As the surface protective PSA sheet 140 shown in FIG. 1(D), it may have a middle layer 143 and a surface layer 144 in addition to a PSA layer 141 and a resin substrate 142.

In the surface protective PSA layer, the number of layers excluding the PSA layer and the resin substrate is typically 5 or lower, preferably 3 or lower, yet more preferably 2 or lower, or particularly preferably 1 or lower. When it is in these ranges, the manufacturing cost can be reduced.

The surface protective PSA sheet may have a release liner.

Examples of the release liner material include polyolefin resin such as polyethylene (PE) and polypropylene (PP); and fluororesin such as polytetrafluoroethylene. In typical, the face of the release liner adhered to the PSA layer is subjected to release treatment.

The surface protective PSA sheet has a thickness of typically 35 μm to 100 μm; preferably 40 μm or greater, more preferably 45 μm or greater, yet more preferably 50 μm or greater, or particularly preferably 55 μm or greater; and preferably 90 μm or less, more preferably 85 μm [symbol] less, or particularly preferably 75 μm or less. When it is in these ranges, mechanical strength and conformability to adherend structures are readily obtained while peeling and lifting can be effectively suppressed. The thickness of the surface protective PSA sheet refers to a value determined by a cross-sectional analysis using an optical microscope, electron microscope, etc.

The surface protective PSA sheet has a tensile modulus of elasticity of 180 MPa to 330 MPa in the machine direction (MD) as well as in the transverse direction (TD) perpendicular to MD. The “machine direction (MD)” refers to the direction in which the surface protective PSA sheet flows during production, processing, etc.; and the “transverse direction (TD) perpendicular to MD” refers to the direction vertical to MD (see FIG. 2).

The “tensile modulus of elasticity” refers to the quotient of the difference in “tensile stress” (σ_{0.25%}−σ_{0.05%}) when the “tensile strain” is between 0.25% and 0.05% and the difference in “tensile strain” (ε_{0.25%}−ε_{0.05%}) when the “tensile strain” is between 0.25% and 0.05% (i.e. the value obtained by dividing (σ_{0.25%}−σ_{0.05%}) by (ε_{0.25%}−ε_{0.05%})) in the tensile property test under the following conditions. Other conditions not mentioned below shall follow JIS K7161:1994 (a translation of ISO 527-1 with no changes in the technical matters or template for standards) and JIS K7127:1989.

### (Conditions for Tensile Property Test)

Gauge length L: 25 mm
Chuck distance: 50 mm
Speed of testing v: 0.5 mm/min
Method for determining tensile strain: non-contact digital video extensometer

The surface protective PSA sheet has a tensile modulus of elasticity in the mechanical direction (MD) of preferably 190 MPa or greater, more preferably 200 MPa or greater, yet more preferably 205 MPa or greater, or particularly preferably 210 MPa or greater; and preferably 320 MPa or less, more preferably 310 MPa or less, yet more preferably 300 MPa or less, or particularly preferably 290 MPa or less. When it is in these ranges, mechanical strength and conformability to adherend structures are readily obtained while peeling and lifting can be effectively suppressed.

The surface protective PSA sheet has a tensile modulus of elasticity in the transverse direction (TD) perpendicular to MD of preferably 190 MPa or greater, more preferably 200 MPa or greater, yet more preferably 205 MPa or greater, or particularly preferably 210 MPa or greater; and preferably 320 MPa or less, more preferably 310 MPa or less, yet more preferably 300 MPa or less, or particularly preferably 290 MPa or less. When it is in these ranges, mechanical strength and conformability to adherend structures are readily obtained while peeling and lifting can be effectively suppressed.

The surface protective PSA sheet has a TD-to-MD ratio of tensile modulus of elasticity (TD tensile modulus of elasticity/MD tensile modulus of elasticity) of preferably 0.5 or higher, more preferably 0.6 or higher, yet more preferably 0.7 or higher, or particularly preferably 0.8 or higher; and preferably 1.5 or lower, more preferably 1.4 or lower, yet more preferably 1.3 or lower, or particularly preferably 1.2 or lower. When it is in these ranges, mechanical strength and conformability to adherend structures are readily obtained while peeling and lifting can be effectively suppressed.

The surface protective PSA sheet is not particularly limited with respect to other features. Described below are preferable test values measured or determined by “glass haze test,” “180° peel test,” “constant load peel test,” and “repulsion test.”

### (Glass Haze Test)

With the PSA layer on top, a circular PSA sheet test piece of 80 mm in diameter is placed in a glass vial of 85 mm in inner diameter at the opening, 80 mm in inner diameter at the bottom and 190 mm in height. The glass vial is placed in an oil bath (oil depth 150 mm) and the opening of the glass vial is covered with a glass plate. With a weight placed on the glass plate, the vial is left standing for a time period shown below. It is noted that the top face of the glass plate is cooled at 21° C. Both before and after standing, using a glossmeter or the like, reflectance of 60° incident light by the glass plate is measured and substituted into the equation below to determine the “haze prevention rate.”

Haze prevention rate (%)=(Reflectance [symbol] standing)/(reflectance of glass plate before left standing)×100

(Condition 1) temperature: 80° C.; time: 2 hours

(Condition 2) temperature: 100° C., time: 2 hours

### (180° Peel Test)

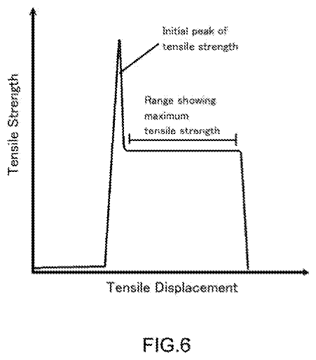

In an atmosphere at room temperature, a 20 mm wide PSA sheet is press-bonded to an adherend shown below at 2 kg×one reciprocation and left standing at a temperature shown below for a time period shown below after applied to the adherend. Subsequently, using a tensile tester, it is peeled in the 180° direction at 300 mm/min and the maximum tensile strength is measured excluding the initial peak of tensile strength as shown in FIG. 6. The mean value is determined as the “peel strength.”

(Condition 1)

Adherend: polypropylene craft sheet with arithmetic mean surface roughness Ra 14.69 μm, temperature: room temperature, time: 30 minutes

(Condition 2)

Adherend: polypropylene craft sheet with arithmetic mean surface roughness Ra 14.69 μm, temperature: room temperature, time: 24 hours

(Condition 3)

Adherend: polypropylene craft sheet with arithmetic mean surface roughness Ra 14.69 μm, temperature: 80° C., time: 168 hours

(Condition 4)

Adherend: BA5-treated SUS430, temperature: room temperature, time: 24 hours

(Condition 5)

Adherend: BA5-treated SUS430, temperature: 80° C., time: 168 hours

### (Constant Load Peel Test)

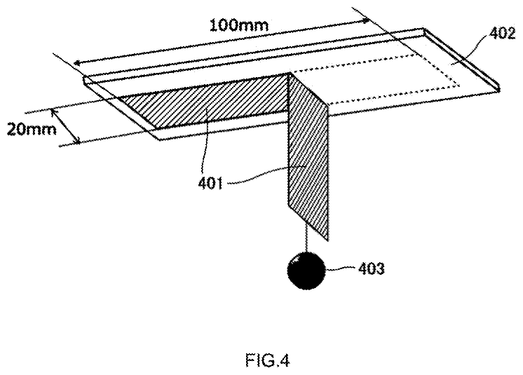

In an atmosphere at room temperature, a 20 mm wide PSA sheet is press-bonded to an adherend (the polypropylene craft sheet above is used) at 2 kg×one reciprocation and left standing in the room temperature atmosphere for 30 minutes after applied to the adherend. Subsequently, as shown in FIG. 4, with the PSA sheet-bearing face of the PP craft sheet 402 down, a 1 [symbol] and after one hour, the “peel distance” is measured.

(Repulsion test)

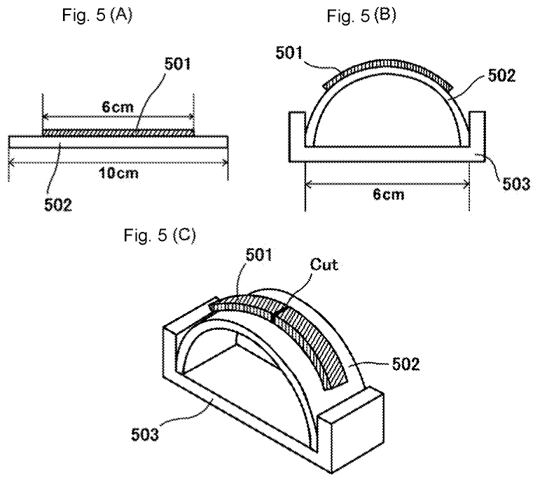

To a 3 cm wide, 10 cm long adherend (the polypropylene craft sheet above is used), a 10 mm wide by 6 cm PSA sheet is press-bonded with a hand-held roller moved back and forth once (FIG. 5(A)) and left standing in an atmosphere at room temperature for 30 minutes after applied to the adherend. Subsequently, using a specialty jig 503 as shown in FIG. 5(B), the resultant is warped to an edge-to-edge distance of 6 cm. As shown in FIG. 5(C), the PSA sheet is cut at the center and left standing at a temperature shown below for a time period shown below. After this, the “peel distance” (the total length of segments where the PSA sheet has peeled and lifted at both sides of the cut) is measured.

(Condition 1) temperature: room temperature, time: 1 hour

(Condition 2) temperature: 40° C., time: 1 hour

In a glass haze test where the surface protective PSA sheet is left standing at 80° C. for two hours, it has a haze prevention rate of preferably 80% or higher, more preferably 85% or higher, yet more preferably 90% or higher, or particularly preferably 92% or higher.

In a glass haze test where the surface protective PSA sheet is left standing at 100° C. for two hours, it has a haze prevention rate of preferably 80% or higher, more preferably 85% or higher, yet more preferably 90% or higher, or particularly preferably 92% or higher.

When it is in these ranges, so-called “fogging” where windshield and the like of an automobile, etc., is fogged can be reduced.

In a 180° peel test where the surface protective PSA sheet is applied to a polypropylene craft sheet at room temperature and left standing for 30 minutes, it has a peel strength of preferably 0.8 N/20 mm or greater, more preferably 1.0 N/20 mm or greater, yet more preferably 1.2 N/20 mm or greater, or particularly preferably 1.4 N/20 mm or greater; and preferably 10 N/20 mm or less, more preferably 8 N/20 mm or less, yet more preferably 6 N/20 mm or less, or p [symbol] less.

In a 180° peel test where the surface protective PSA sheet is applied to a polypropylene craft sheet at room temperature and left standing for 24 hours, it has a peel strength of preferably 0.8 N/20 mm or greater, more preferably 1.0 N/20 mm or greater, yet more preferably 1.2 N/20 mm or greater, or particularly preferably 1.4 N/20 mm or greater; and preferably 10 N/20 mm or less, more preferably 8 N/20 mm or less, yet more preferably 6 N/20 mm or less, or particularly preferably 5 N/20 mm or less.

In a 180° peel test where the surface protective PSA sheet is applied to a polypropylene craft sheet at 80° C. and left standing for 168 hours, it has a peel strength of preferably 0.8 N/20 mm or greater, more preferably 1.0 N/20 mm or greater, yet more preferably 1.2 N/20 mm or greater, or particularly preferably 1.4 N/20 mm or greater; and preferably 10 N/20 mm or less, more preferably 8 N/20 mm or less, yet more preferably 6 N/20 mm or less, or particularly preferably 5 N/20 mm or less.

When it is in these ranges, with excellent bonding strength to low-polar rough adherends, peeling and lifting can be suppressed and an increase in bonding strength with time can be inhibited.

In a 180° peel test where the surface protective PSA sheet is applied to SUS430 at room temperature and left standing for 24 hours, it has a peel strength of preferably 0.8 N/20 mm or greater, more preferably 1.0 N/20 mm or greater, yet more preferably 1.2 N/20 mm or greater, or particularly preferably 1.4 N/20 mm or greater; and preferably 15 N/20 mm or less, more preferably 13 N/20 mm or less, yet more preferably 11 N/20 mm or less, or particularly preferably 10 N/20 mm or less.

In a 180° peel test where the surface protective PSA sheet is applied to SUS430 at 80° C. and left standing for 168 hours, it has a peel strength of preferably 0.8 N/20 mm or greater, more preferably 1.0 N/20 mm or greater, yet more preferably 1.2 N/20 mm or greater, or particularly preferably 1.4 N/20 mm or greater; and preferably 15 N/20 mm or less, more preferably 13 N/20 mm or less, yet more preferably 11 N/20 mm or less, or particularly preferably 10 N/20 mm or less.

When it is in these ranges, with excelle [symbol] adherends, peeling and lifting can be suppressed and an increase in bonding strength with time can be inhibited.

In a constant load peel test, the surface protective PSA sheet shows a peel distance of preferably 50 mm/h or less, more preferably 40 mm/h or less, yet more preferably 30 mm/h or less, or particularly preferably 25 mm/h or less. When it is in these ranges, peeling and lifting are suppressed and long-term stable protection can be obtained.

In a repulsion test where the surface protective PSA sheet is centrally cut and then left standing at room temperature for one hour, it shows a peel distance of preferably 5 mm/h or less, more preferably 4 mm/h or less, yet more preferably 3 mm/h or less, or particularly preferably 2 mm/h or less. When it is in these ranges, peeling and lifting are suppressed and long-term stable protection can be obtained.

The method for producing the surface protective PSA sheet is not particularly limited and common knowledge can be suitably employed to carry out production. A particularly preferable method for producing the surface protective PSA sheet includes the following PSA composition preparation step, resin substrate preparation step and PSA layer forming step (hereinafter, sometimes abbreviated to a “surface protective PSA sheet production method”):
a step of preparing a PSA composition comprising a (meth)acrylic copolymer and a tackifier (hereinafter, sometimes abbreviated to a “PSA composition preparation step”)
a step of preparing a resin substrate (hereinafter, sometimes abbreviated to a “resin substrate preparation step”)
a step of forming a PSA layer on the resin substrate, using the PSA composition (hereinafter, sometimes abbreviated to a “PSA layer forming step”

For detailed conditions and the like of the PSA composition preparation step, resin substrate preparation step and PSA layer forming step, the details described earlier can be referenced.

A preferable method for producing the s [symbol] the following PSA composition preparation step, resin substrate preparation step and PSA layer forming step (hereinafter, sometimes abbreviated to a “surface protective PSA sheet production method”):
a step of heating the product obtained via the PSA layer forming step (hereinafter, sometimes abbreviated to a “heating step”)
a step of forming through holes in the product obtained via the PSA layer forming step or the heating step (hereinafter, sometimes abbreviated to a “through hole forming step”)

For detailed conditions and the like of the heating step and the through hole forming step, the details described earlier can be referenced.

### EXAMPLES

The present invention is described further in detail with working examples, but suitable modifications can be made as long as within the purpose of the invention.

Accordingly, the specific examples shall not limit the scope of the invention.

### Examples 1 to 8, Comparative Examples 1 to 6

To 100 parts by mass of non-volatiles of (meth)acrylic copolymer synthesized from monomers in amounts shown in Table 1, were added tackifier(s) in amounts shown in Table 1 to prepare a composition. To 100 parts by mass of non-volatiles of (meth)acrylic copolymer, was further admixed 0.1 part by mass of epoxy-based crosslinking agent (product name TETRAD-C available from Mitsubishi Gas Chemical Company, Inc.) to prepare a PSA composition. It is noted that only in Comparative Example 1 alone, TETRAD-C was not added to prepare the PSA composition.

The resulting PSA composition was applied to one face of a polyethylene substrate (product name TRETEC CF47W available from Toray Advanced Film Co., Ltd.; about 50 μm thick) to a dried thickness of about 13 μm and allowed to dry at 70° C. for 2 minutes to prepare a surface protective PSA sheet for each of Examples 1 to 8 and Comparative Examples 1 to 6.

The surface protective PSA sheets of Examples 1 to 8 and Comparative Examples 1 to 6 were processed with a rotary cutter to form linear through holes (short side: 60 μm, long side: 1.0 mm) with adjacent through holes apart by 0.6 mm.

With respect to each of the surface protective PSA sheet of Examples 1 to 8 and Comparative Examples 1 to 6, the MD and TD “tensile moduli of elasticity” were determined. In addition, the following “glass haze test,” “180° peel test,” “touch-up paint peeling test,” “constant load peel test” and “repulsion test” were carried out to determine the corresponding test values. The results are shown in Tables 1 to 4. In these Tables, (ND) indicates that it was not measured or tested.

### (Tensile Property Test)

A test piece cut to 100 mm×10 mm×10.05-0.06 mm (see JIS K7127:1989) was set in a universal material tester (INSTRON 5582). While tensile testing was carried out at a gauge length of 25 mm at a chuck distance of 50 mm at a testing speed of 0.5 mm/min, the tensile stress was measured with the tensile tester and the tensile strain was determined with a high-performance AVE video extensometer (available from Instron, video lens: 200 mm wide angle lens used) (test environment: 23±2° C., 50±10% RH). The difference in tensile stress (σ_{0.25%}−σ_{0.05%}) when the tensile strain was between 0.25% and 0.05% was divided by the difference in tensile strain (ε_{0.25%}−ε_{0.05%}) when the tensile strain was between 0.25% and 0.05% to determine the tensile modulus of elasticity (the mean value of five tests).

### (Glass Haze Test)

This was carried out using a fogging tester available from Thermo SCIENTIFIC. In particular, circular PSA sheet test pieces of 80 mm in diameter were placed with PSA layer sides up in glass vials of 85 mm in inner diameter at the opening, 80 mm in inner diameter at the bottom and 190 mm in height. The glass vials were placed in oil bathes (oil depth 150 mm) heated to the temperatures shown in Tables 1 to 4. The openings of the glass vials were covered with glass plates. With weights placed on the glass plates, the vials were left standing for time periods shown in Tables 1 to 4. The top faces of glass plates were cooled at 21° C. Before and after standing, using a glossmeter (product name REFO 60 available from HACH LANGE GmbH), reflectance of 60° incident light by each glass plate was measured and substituted into the equation below to determine the “haze prevention rate.”

Haze prevention rate (%)=(Reflectance [symbol] standing)/(reflectance of glass plate before left standing)×100

### (180° Peel Test)

In an atmosphere at room temperature, a 20 mm wide PSA sheet was press-bonded to the adherends shown in Tables 1 to 4 at 2 kg×one reciprocation. After applied, the resultant was left standing at the temperature and for the time period shown in Tables 1 to 4. Subsequently, using a tensile tester, the PSA sheet was peeled in the 180° direction at 300 mm/min and the maximum tensile strength was measured excluding the initial peak of tensile strength as shown in FIG. 6. Their mean value was determined as the “peel strength.” As the PP craft sheet, was used a product available from Acrysunday Co., Ltd.

### (Touch-Up Paint Peeling Test)

Touch-Up Paint was Applied onto the PP Craft Sheet in an Atmosphere at Room temperature. The application was carried out at a distance of 10 cm to 15 cm at a speed of 10 mm/sec to avoid overlapping.

Subsequently, a 10 mm wide PSA sheet was press-bonded with a roller and left standing at the temperature and for the time period shown in Tables 1 to 4 after the application of the PSA sheet. The PSA sheet was then peeled by hand in the 120° direction. The amount of residual touch-up paint was subjected to sensory evaluation and graded in 0.1 increments according to the scales shown below (i.e. graded in 50 steps). The test was carried out three times for each and the mean of the resulting scores was determined.

0: no peeling

1: ˜5% peeling

2: ˜10% peeling

3: 40% peeling

4: 70% peeling

5: 100% peeling

As the touch-up pen, was used White Touch-up Pen T-50 for Toyota 056 No. 17350 available from SOFT99 Corporation. This was installed in Air Touch available also from SOFT99 Corporation and sprayed.

### (Constant Load Peel Test)

In an atmosphere at room temperature, a 20 mm wide PSA sheet was press-bonded to the PP craft sheet at 2 kg×one reciprocation and left standing in the room temperature atmosphere for 30 minutes after applied. Subsequently, as shown in FIG. 4, with the PP craft sheet 402-bearing face of the PSA sheet down, a 19 g load was applied using a weight 403 and after one hour, the “peel distance” was measured.

### (Repulsion Test)

The PP craft sheet was cut to a 3 cm wide, 10 cm long rectangle. As shown in FIG. 5(A), to the PP craft sheet 502, was press-bonded a 10 mm wide by 6 cm PSA sheet 501 with a hand-held roller 1 rolled back and forth once. The resultant was left standing in an atmosphere at room temperature for 30 minutes after applied. Subsequently, using a specialty jig 503 as shown in FIG. 5(B), the resultant was warped to an edge-to-edge distance of 6 cm. Then, as shown in FIG. 5(C), the PSA sheet 501 was cut at the center and left standing at the temperature and for the time period shown in Tables 1 to 4. After this, the “peel distance” was measured.

### (Hand-Cut Test)

As a sensory evaluation, hand-cut test (by hand-cutting the PSA tape) was conducted five times and the ease of tearing (sensory evaluation) was evaluated based on the following scales:

(Evaluation Scales of Ease of Tearing According to Sensory Evaluation)

Good: easily hand-cut all five times

Intermediate: easily hand-cut four times

Poor: easily hand-cut no more than three times

TABLE 1

| | | | | Ex 1 | Ex 2 | Ex 3 | Ex 4 |
|---|---|---|---|---|---|---|---|
| Specifica- | PSA | Monomers | 2-Ethylhexyl acrylate (2EHA | 98.03 | 51.4 | 51.4 | 51.4 |
| tions | layer | (starting | (×1)) | | | | |
| | | materials) | Butyl acrylate (BA (×2)) | 0 | 47.4 | 47.4 | 47.4 |
| | | (wt %) | Acrylic acid (AA) | 1.96 | 1.0 | 1.0 | 1.0 |
| | | | 2-Hydroxyethyl acrylate | 0 | 0.15 | 0.15 | 0.15 |
| | | | (HEA (×3)) | | | | |
| | | | Vinyl acetate | 0 | 0 | 0 | 0 |
| | | | Trimethylolpropane tri- | 0.01 | 0 | 0 | 0 |
| | | | acrylate | | | | |
| | | | All monomers (starting | 100 | 100 | 100 | 100 |
| | | | materials) combined | | | | |
| | | Tackifier | ARKON P-125 (alicyclic | 10 | 5 | 5 | 5 |
| | | (parts | hydrocarbon resin) | | | | |
| | | by wt) | PENSEL D-135 (rosin resin) | 0 | 10 | 5 | 10 |
| | | Crosslinking | TETRAD-C (epoxy-based | 0.1 | 0.1 | 0.1 | 0.1 |
| | | agent (parts | crosslinking agent) | | | | |
| | | by wt) | | | | | |
| | | Weight average molecular weight (Mw) | | 650,000 | 800,000 | 950,000 | 950,000 |
| | | PSA layer's thickness (um) | | 16 | 13 | 16 | 16 |
| | Resin | Type of resin | | TORETEC ® | TORETEC ® | TORETEC ® | TORETEC ® |
| | substrate | | | CF47W | CF47W | CF47W | CF47W |
| | | Resin substrate's thickness (um) | | 50 | 50 | 50 | 50 |
| | Through | Rotary | 1 mm cut, 0.6 mm uncut | Present | Present | Present | Present |
| | holes | | | | | | |
| Physical | Tensile modulus of elasticity | | MD | 262 | 258 | 258 | 258 |
| properties | (MPa) | | TD | 258 | 244 | 244 | 244 |
| | | | TD/MD | 0.98 | 0.95 | 0.95 | 0.95 |
| Test | Glass haze test (%) | | 80° C. × 2 h | 96 | 95 | 96 | 93 |
| results | | | 100° C. × 2 h | 82 | 84 | 84 | 82 |
| | 180° Peel | PP craft | RT × 0.5 h | 2.05 | 1.76 | 1.94 | 2.34 |
| | test (300 mm/ | sheet | RT × 24 h | 2.38 | 2.10 | 1.52 | 2.03 |
| | min) | (N/20 mm) | 80° C. × 168 h | 2.52 | 1.35 | 1.42 | 1.99 |
| | | SUS430 BA | RT × 24 h | 4.41 | 5.77 | 4.60 | 4.89 |
| | | treatment | 80° C. × 168 h | 4.46 | 6.84 | 4.69 | 5.30 |
| | | (N/20 mm) | | | | | |

| | | | | | |
|---|---|---|---|---|---|
| Touch-up paint peeling test | RT × 24 h | 0.4 | 0.2 | 0.5 | 0.5 |
| Sensory evaluation [Good 0 to 5 | 40° C. × 72 h | 0.2 | 0.3 | 0.3 | 0.3 |
| Poor] | | | | | |
| Constant load peel test (mm/h) | RT × 19 g | 48 | 0 | 0 | 0 |
| Repulsion test (mm/h) | RT × 1 h | 0.9 | 0 | 0 | 0 |
| | 40° C. × 1 h | 0.9 | 0 | 0 | 0 |

| | | | | |
|---|---|---|---|---|
| Ease of hand-cutting | Good | Good | Good | Good |

TABLE 2

| | | | | Ex 5 | Ex 6 | Ex 7 | Ex 8 |
|---|---|---|---|---|---|---|---|
| Specifica- | PSA | Monomers | 2-Ethylhexyl acrylate (2EHA | 51.4 | 51.4 | 51.4 | 51.4 |
| tions | layer | (starting | (×1)) | | | | |
| | | materials) | Butyl acrylate (BA (×2)) | 47.4 | 47.4 | 47.4 | 47.4 |
| | | (wt %) | Acrylic acid (AA) | 1.0 | 1.0 | 1.0 | 1.0 |
| | | | 2-Hydroxyethyl acrylate (HEA | 0.15 | 0.15 | 0.15 | 0.15 |
| | | | (×3)) | | | | |
| | | | Vinyl acetate | 0 | 0 | 0 | 0 |
| | | | Trimethylolpropane tri- | 0 | 0 | 0 | 0 |
| | | | acrylate | | | | |
| | | | All monomers (starting | 100 | 100 | 100 | 100 |
| | | | materials) combined | | | | |
| | | Tackifier | ARKON P-125 (alicyclic | 6.4 | 3.6 | 6.4 | 5 |
| | | (parts | hydrocarbon resin) | | | | |
| | | by wt) | PENSEL D-135 (rosin resin) | 7.2 | 12.8 | 12.8 | 14 |
| | | Crosslinking | TETRAD-C (epoxy-based | 0.1 | 0.1 | 0.1 | 0.1 |
| | | agent (parts | crosslinking agent) | | | | |
| | | by wt) | | | | | |
| | | Weight average molecular weight (Mw) | | 800,000 | 800,000 | 800,000 | 800,000 |
| | | PSA layer's thickness (um) | | 13 | 13 | 13 | 13 |
| | Resin | Type of resin | | TORETEC ® | TORETEC ® | TORETEC ® | TORETEC ® |
| | substrate | | | CF47W | CF47W | CF47W | CF47W |
| | | Resin substrate's thickness (um) | | 50 | 50 | 50 | 50 |
| | Through holes | Rotary | 1 mm cut, 0.6 mm uncut | Present | Present | Present | Present |
| Physical | Tensile modulus of elasticity | | MD | 258 | 258 | 258 | 258 |
| properties | (MPa) | | TD | 244 | 244 | 244 | 244 |
| | | | TD/MD | 0.95 | 0.95 | 0.95 | 0.95 |
| Test | Glass haze test (%) | | 80° C. × 2 h | 96 | 93 | 92 | 93 |
| results | | | 100° C. × 2 h | 85 | 83 | 83 | 82 |
| | 180° Peel | PP craft | RT × 0.5 h | 1.54 | 2.04 | 1.76 | 2.16 |
| | test (300 mm/ | sheet | RT × 24 h | 1.79 | 2.22 | 2.35 | 1.94 |
| | min) | (N/20 mm) | 80° C. × 168 h | 1.35 | 1.92 | 1.87 | 1.96 |
| | | SUS430 BA | RT × 24 h | 4.06 | 5.08 | 5.16 | 4.82 |
| | | treatment | 80° C. × 168 h | 4.23 | 5.65 | 5.63 | 5.75 |
| | | (N/20 mm) | | | | | |

| | | | | | |
|---|---|---|---|---|---|
| Touch-up paint peeling test | RT × 24 h | 0.1 | 0.5 | 0.2 | 0.5 |
| Sensory evaluation [Good 0 to 5 | 40° C. × 72 h | 0.8 | 0.7 | 0.4 | 0.7 |
| Poor] | | | | | |
| Constant load peel test (mm/h) | RT × 19 g | 33 | 30.5 | 14.3 | 11.5 |
| Repulsion test (mm/h) | RT × 1 h | 40.8 | 7.8 | 0.8 | 7.3 |
| | 40° C. × 1 h | 57.5 | 13 | 0.3 | 0.5 |

| | | | | |
|---|---|---|---|---|
| Ease of hand-cutting | Good | Good | Good | Good |

TABLE 3

| | | | | Comp. | Comp. | Comp. | Comp. |
|---|---|---|---|---|---|---|---|
| | | | | Ex 1 | Ex 2 | Ex 3 | Ex 4 |
| Specifica- | PSA | Monomers | 2-Ethylhexyl acrylate (2EHA | (ND) | 93.5 | 93.5 | 49.9 |
| tions | layer | (starting | (×1)) | | | | |
| | | materials) | Butyl acrylate (BA (×2)) | (ND) | 0 | 0 | 46.4 |
| | | (wt %) | Acrylic acid (AA) | 4.0 | 3.5 | 3.5 | 3.5 |
| | | | 2-Hydroxyethyl acrylate (HEA | (ND) | 0.1 | 0.1 | 0.15 |
| | | | (×3)) | | | | |
| | | | Vinyl acetate | (ND) | 3.0 | 3.0 | 0 |
| | | | Trimethylolpropane tr- | (ND) | 0 | 0 | 0 |
| | | | iacrylate | | | | |
| | | | All monomers (starting | 100 | 100 | 100 | 100 |
| | | | materials) combined | | | | |
| | | Tackifier | ARKON P-125 (alicyclic | 0 | 10 | 15 | 10 |
| | | (parts | hydrocarbon resin) | | | | |
| | | by wt) | PENSEL D-135 (rosin resin) | 10 | 0 | 0 | 25 |
| | | Crosslinking | TETRAD-C (epoxy-based | 0 | 0.1 | 0.1 | 0.1 |
| | | agent (parts | crosslinking agent) | | | | |
| | | by wt) | | | | | |
| | | Weight average molecular weight | | 600,000 | 800,000 | 800,000 | 1,100,000 |
| | | (Mw) | | | | | |
| | | PSA layer's thickness (um) | | 16 | 16 | 16 | 16 |
| | Resin | Type of resin | | TORETEC ® | TORETEC ® | TORETEC ® | TORETEC ® |
| | substrate | | | CF47W | CF47W | CF47W | CF47W |
| | | Resin substrate's thickness (um) | | 50 | 50 | 50 | 50 |
| | Through | Rotary | 1 mm cut, 0.6 mm uncut | Present | Present | Present | Present |
| | holes | | | | | | |
| Physical | Tensile modulus (MPa) | | MD | 262 | 258 | 258 | 258 |
| properties | of elasticity | | TD | 258 | 244 | 244 | 244 |
| | | | TD/MD | 0.98 | 0.95 | 0.95 | 0.95 |
| Test | Glass haze test (%) | | 80° C. × 2 h | 92 | 93 | 89 | 83 |
| results | | | 100° C. × 2 h | 82 | 84 | 78 | 71 |
| | 180° Peel | PP craft | RT × 0.5 h | 0.50 | 1.21 | 1.21 | 1.59 |
| | test (300 mm/ | sheet | RT × 24 h | 0.45 | 1.20 | 1.23 | 2.02 |
| | min) | (N/20 mm) | 80° C. × 168 h | 0.67 | 1.55 | 1.22 | 1.73 |
| | | SUS430 BA | RT × 24 h | 3.76 | 5.54 | 4.31 | 11.43 |
| | | treatment | 80° C. × 168 h | (ND) | (ND) | (ND) | (ND) |
| | | (N/20 mm) | | | | | |

| | | | | | |
|---|---|---|---|---|---|
| Touch-up paint peeling test | RT × 24 h | 0.5 | 4.5 | 4.5 | 3.5 |
| Sensory evaluation [Good 0 to 5 | 40° C. × 72 h | 0 | 0.5 | 0 | 0.5 |
| Poor] | | | | | |
| Constant load peel test (mm/h) | RT × 19 g | 178 | 95 | 128 | 0 |
| Repulsion test (mm/h) | RT × 1 h | 2.0 | 1.0 | 1.3 | 0 |
| | 40° C. × 1 h | 1.8 | 1.0 | 1.1 | 0 |

| | | | | |
|---|---|---|---|---|
| Ease of hand-cutting | Good | Good | Good | Good |

TABLE 4

| | | | | Comp. Ex 5 | Comp. Ex. 6 |
|---|---|---|---|---|---|
| Specifica- | PSA | Monomers | 2-Ethylhexyl acrylate (2EHA | 51.4 | 51.4 |
| tions | layer | (starting | (×1)) | | |
| | | materials) | Butyl acrylate (BA (×2)) | 47.4 | 47.4 |
| | | (wt %) | Acrylic acid (AA) | 1.0 | 1.0 |
| | | | 2-Hydroxyethyl acrylate (HEA | 0.15 | 0.15 |
| | | | (×3)) | | |
| | | | Vinyl acetate | 0 | 0 |
| | | | Trimethylolpropane triacrylate | 0 | 0 |
| | | | All monomers (starting materials) | 100 | 100 |
| | | | combined | | |
| | | Tackifier | ARKON P-125 (alicyclic | 10 | 0 |
| | | (parts | hydrocarbon resin) | | |
| | | by wt) | PENSEL D-135 (rosin resin) | 25 | 0 |
| | | Crosslinking | TETRAD-C (epoxy-based | 0.1 | 0.1 |
| | | agent (parts | crosslinking agent) | | |
| | | by wt) | | | |
| | | Weight average molecular weight (Mw) | | 950,000 | 950,000 |
| | | PSA layer's thickness (um) | | 16 | 16 |
| | Resin | Type of resin | | TORETEC ® | TORETEC ® |
| | substrate | | | CF47W | CF47W |
| | | Resin substrate's thickness (um) | | 50 | 50 |
| | Through | Rotary | 1 mm cut, 0.6 mm uncut | Present | Present |
| | holes | | | | |
| Physical | Tensile modulus of | | MD | 258 | 258 |
| properties | elasticity (MPa) | | TD | 244 | 244 |
| | | | TD/MD | 0.95 | 0.95 |
| Test | Glass haze test (%) | | 80° C. × 2 h | 82 | 96 |
| results | | | 100° C. × 2 h | 71 | 88 |
| | 180° Peel | PP craft | RT × 0.5 h | 3.45 | 1.15 |
| | test (300 mm/min) | sheet | RT × 24 h | 4.28 | 0.83 |
| | | (N/20 mm) | 80° C. × 168 h | 3.82 | 1.46 |
| | | SUS430 BA | RT × 24 h | 10.02 | 2.67 |
| | | treatment | 80° C. × 168 h | 10.34 | 3.7 |
| | | (N/20 mm) | | | |

| | | | |
|---|---|---|---|
| Touch-up paint peeling test | RT × 24 h | 0.1 | 1.5 |
| Sensory evaluation [Good 0 to 5 | 40° C. × 72 h | 0.5 | 0.1 |
| Poor] | | | |
| Constant load peel test (mm/h) | RT × 19 g | 0 | 72 |
| Repulsion test (mm/h) | RT × 1 h | 0 | 35.5 |
| | 40° C. × 1 h | 0 | 47.5 |

| | | |
|---|---|---|
| Ease of hand-cutting | Good | Good |

### INDUSTRIAL APPLICABILITY

The surface protective PSA sheet as an embodiment of this invention can be applied to the surfaces of interiors, exteriors and parts of automobiles, aircraft, watercraft and the like and used to prevent the surfaces from getting damaged and accumulating dirt. In particular, it is favorable as a surface protective PSA sheet whose purpose is temporary application and removal after an intended step or after a certain period (after the protection purpose is fulfilled).

### REFERENCE SIGNS LIST

110 surface protective PSA sheet
111 PSA layer
112 resin substrate
120 surface protective PSA sheet
121 PSA layer
122 resin substrate
123 middle layer
130 surface protective PSA sheet
131 PSA layer
132 resin substrate
134 surface layer
140 surface protective PSA sheet
141 PSA layer
142 resin substrate
143 middle layer
144 surface layer
200 surface protective PSA sheet
201 resin substrate face
202 through hole
203 direction in which through holes are arranged linearly and regularly
204 distance between adjacent through holes
310 through hole having a macroscopically linear (microscopically rectangular) shape in resin substrate face
311 direction in which through holes are arranged linearly and regularly
312 distance between adjacent through holes
313 short side of through hole
314 long side of through hole
320 through hole having a macroscopically linear (microscopically rectangular) shape in resin substrate face
321 direction in which through holes are arranged linearly and regularly
322 distance between adjacent through holes
323 diameter of through hole
324 diameter of through hole
401 surface protective PSA sheet
402 PP craft sheet
403 weight
501 surface protective PSA sheet
502 PP craft sheet
503 specialty jig

1. A surface protective pressure-sensitive adhesive sheet having a pressure-sensitive adhesive layer and a resin substrate supporting the pressure-sensitive adhesive layer, characterized by satisfying the following conditions (a1), (a1-1) and (c1):
(a1) the pressure-sensitive adhesive layer is formed from a pressure-sensitive adhesive composition comprising a (meth)acrylic copolymer and a tackifier; and the tackifier content of the pressure-sensitive adhesive composition is 1.0 part to 30 parts by mass with the (meth)acrylic copolymer being 100 parts by mass;
(a1-1) of the (meth)acrylic copolymer, 0.1% to 2.8% by mass is attributed to a structural unit that includes at least one species of functional groups selected from the group consisting of a carboxyl group and a salt thereof as well as a sulfo group and a salt thereof; and
(c1) the surface protective pressure-sensitive adhesive sheet has a tensile modulus of elasticity of 180 MPa to 330 MPa in its machine direction (MD) as well as in its transverse direction (TD) perpendicular to the MD.

2. The surface protective pressure-sensitive adhesive sheet according to claim 1, further satisfying the following condition (a1-2):
(a1-2) the (meth)acrylic copolymer has a weight average molecular weight of 100,000 to 1,500,000.

3. The surface protective pressure-sensitive adhesive sheet according to claim 1, further satisfying the following condition (a1-3):
(a1-3) of the (meth)acrylic copolymer, 20% to 80% by mass is attributed, as a structural unit, to at least one species of structure selected from the group consisting of a structure derived from a (meth)acrylate represented by a formula (x1) shown below and a structure derived from a (meth)acrylamide represented by a formula (y1) shown below: 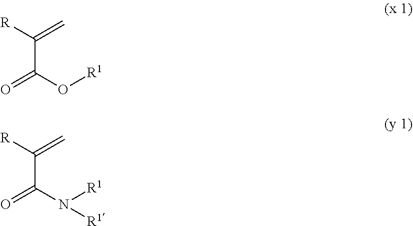
(in the formulas (x1) and (y1), R is a hydrogen atom or a methyl group; R¹ is a hydrocarbon group with 7 to 20 carbon atoms possibly including at least one species of functional groups selected from the group consisting of an oxa group, a carbonyl group and an oxycarbonyl group; and R^{1′} is a hydrogen atom or a hydrocarbon group with 1 to 6 carbon atoms possibly including at least one species of functional groups selected from the group consisting of an oxa group, a carbonyl group and an oxycarbonyl group.)

4. The surface protective pressure-sensitive adhesive sheet according to claim 1, further satisfying the following condition (a1-4):
(a1-4) of the (meth)acrylic copolymer, 20% to 80% by mass is attributed, as a structural unit, to at least one species of structure selected from the group consisting of a structure derived from a (meth)acrylate represented by a formula (x2) shown below and a structure derived from a (meth)acrylamide represented by a formula (y2) shown below: 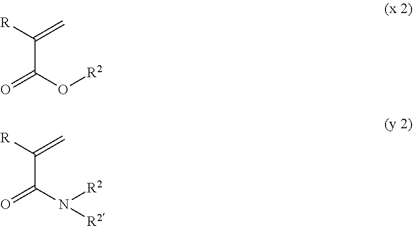
(in the formulas (x2) and (y2), R is a hydrogen atom or a methyl group; R² is a hydrocarbon group with 1 to 6 carbon atoms possibly including an oxa group; and R^{2′} is a hydrogen atom or a hydrocarbon group with 1 to 3 carbon atoms possibly including an oxa group.)

5. The surface protective pressure-sensitive adhesive sheet according to claim 1, further satisfying the following condition (a1-5):
(a1-5) of the (meth)acrylic copolymer, 0.05% to 1% by mass is attributed, as a structural unit, to at least one species of structure selected from the group consisting of a structure derived from a (meth)acrylate represented by a formula (x3) shown below and a structure derived from a (meth)acrylamide represented by a formula (y3) shown below: 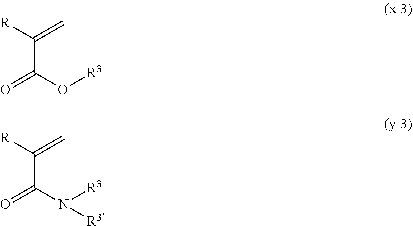
(in the formulas (x3) and (y3), R is a hydrogen atom or a methyl group; R³ is a hydroxyl group-containing hydrocarbon group with 1 to 12 carbon atoms possibly including an oxa group; and R^{3′} is a hydrogen atom or a hydroxyl group-containing hydrocarbon group with 1 to 3 carbon atoms possibly including an oxa group.)

6. The surface protective pressure-sensitive adhesive sheet according to claim 1, further satisfying the following condition (a1-6):
(a1-6) the pressure-sensitive adhesive composition comprises, as the tackifier, an alicyclic hydrocarbon resin and a rosin resin, wherein the alicyclic hydrocarbon resin content of the pressure-sensitive adhesive composition is 1.0 part to 20 parts by mass with the (meth)acrylic copolymer being 100 parts by mass, and the rosin resin content of the pressure-sensitive adhesive composition is 1.0 part to 28 parts by mass with the (meth)acrylic copolymer being 100 parts by mass.

7. The surface protective pressure-sensitive adhesive sheet according to claim 1, further satisfying the following condition (a2):
(a2) the pressure-sensitive adhesive layer has a thickness of 5.0 μm to 30 μm.

8. The surface protective pressure-sensitive adhesive sheet according to claim 1, further satisfying the following condition (b1):
(b1) the resin substrate has a thickness of 30 μm to 70 μm.

9. The surface protective pressure-sensitive adhesive sheet according to claim 1, further satisfying the following condition (b2):
(b2) the resin substrate has a plurality of through holes pierced in the thickness direction of the resin substrate, appearing as lines and/or dots in shape on the resin substrate face, and arranged linearly and regularly in at least one direction, having a distance of 0.20 mm to 1.0 mm between adjacent through holes.

10. The surface protective pressure-sensitive adhesive sheet according to claim 1, that is to be removed after a protection purpose is fulfilled.
